(19) United States
(12) Patent Application Publication
(10) Pub. No.: US 2025/0390484 A1
(43) Pub. Date: Dec. 25, 2025

(54) BLOCK DATA PROCESSING METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Zhuguang SHAO, Shenzhen (CN)

(21) Appl. No.: 19/315,813

(22) Filed: Sep. 1, 2025

Related U.S. Application Data
(63) Continuation of application No. PCT/CN2023/132793, filed on Nov. 21, 2023.

(30) Foreign Application Priority Data
Jun. 28, 2023 (CN) 202310781850.9

(51) Int. Cl. G06F 16/23; G06F 16/22

(52) U.S. Cl. CPC G06F 16/2365; G06F 16/2255

(57) ABSTRACT

A block data processing method executed by an electronic device includes obtaining a voting right need of a target service object, and constructing a service node group of the target service object according to the voting right need of the target service object. The service node group includes a service node of the target service object and at least one shadow node corresponding to the service node. The service node is configured to perform block data processing according to stored block ledger data. Block data processing performed by each of the at least one shadow node is kept consistent with block data processing performed by the service node. The at least one shadow node does not store the block ledger data for block data processing.

### CROSS-REFERENCE RELATED APPLICATIONS

This application is a continuation of International Application No. PCT/CN2023/132793, filed on Nov. 21, 2023, which claims priority to Chinese Patent Application No. 202310781850.9, filed with the China National Intellectual Property Administration on Jun. 28, 2023 and entitled “BLOCK DATA PROCESSING METHOD AND APPARATUS, ELECTRONIC DEVICE, AND STORAGE MEDIUM,” the entire contents of both of which are incorporated herein by reference.

### FIELD OF THE TECHNOLOGY

This application relates to the field of computer technologies, and in particular, to a block data processing technology.

### BACKGROUND OF THE DISCLOSURE

With the continuous development of computer networks, technologies related to blockchains have become increasingly mature. Blockchain is a new application mode of computer technologies of, e.g., distributed data storage, point-to-point transmission, consensus mechanisms, and encryption algorithms. Considering that information stored on a blockchain cannot be forged or tampered with, more and more enterprises start to build service nodes on the blockchain to store service data on corresponding service nodes and achieve management of service data.

However, for some service systems, due to the varying importance of their service nature, different service systems have different weights in the same blockchain, i.e., the voting values in the blockchain are different. In this case, for service systems with higher weights, it is needed to deploy a corresponding number of consensus nodes on the blockchain. For example, assuming that the entire blockchain network includes three service systems as participants, in a case that participant A wishes to have a higher proportion of discourse power, it needs to deploy more consensus nodes. For example, for participants A, B, and C, when participant A requires higher discourse power, 2 consensus nodes may be deployed for participant A, and 1 consensus node may be deployed for each of participant B and participant C. At this time, participant A has 2 consensus nodes and has higher discourse power for voting transactions initiated in the blockchain.

However, since each consensus node needs to store a ledger, for participants who require higher discourse power, having more consensus nodes also means occupying more resources, such as central processing unit (CPU) resources and storage resources, resulting in significant resource consumption.

### SUMMARY

In accordance with the disclosure, there is provided a block data processing method executed by an electronic device including obtaining a voting right need of a target service object, and constructing a service node group of the target service object according to the voting right need of the target service object. The service node group includes a service node of the target service object and at least one shadow node corresponding to the service node. The service node is configured to perform block data processing according to stored block ledger data. Block data processing performed by each of the at least one shadow node is kept consistent with block data processing performed by the service node. The at least one shadow node does not store the block ledger data for block data processing.

Also in accordance with the disclosure, there is provided a block data processing method executed by a shadow node including extracting, in response to proposal information transmitted by a service node of a target service object, block information from the proposal information, performing proposal processing, and generating a proposal notification. The proposal notification is configured for triggering one or more nodes to perform block locking processing. The service node and the shadow node are located in a service node group of the target service object. The method further includes, in response to block locking voting information transmitted by the service node, extracting first voting content from the block locking voting information and performing block locking processing on the proposal notification by using the first voting content, and in response to block commitment voting information transmitted by the service node, extracting second voting content from the block commitment voting information and performing block commitment processing by using the second voting content to complete consensus on the block information. The second voting content includes a result of block locking processing performed by the one or more nodes.

Also in accordance with the disclosure, there is provided a block data processing method executed by an electronic device including determining a service node of a target service object from a plurality of nodes of a blockchain network, calculating a number of shadow nodes to be configured for the service node according to a voting right weight expected by the service node and a number of nodes of the blockchain network, and configuring one or more shadow nodes for the service node according to the number of shadow nodes. The service node stores block ledger data for block data processing. Block data processing performed by each of the one or more shadow nodes is kept consistent with block data processing performed by the service node. The one or more shadow nodes do not store the block ledger data for block data processing.

### BRIEF DESCRIPTION OF THE DRAWINGS

To describe the technical solutions of the embodiments of this application more clearly, the following briefly introduces the accompanying drawings needed for describing the embodiments. It is clear that the accompanying drawings in the following description show only some embodiments of this application, and a person of ordinary skill in the art may still derive other drawings from these accompanying drawings without creative efforts.

FIG. 1 is a schematic structural deployment diagram showing a relevant implementation environment in the related technologies.

FIG. 2 is a schematic diagram showing an implementation environment of data processing according to an embodiment of this application.

FIG. 3 is a schematic structural deployment diagram showing an implementation environment according to an embodiment of this application.

FIG. 4 is a schematic diagram showing application of a service system according to an embodiment of this application.

FIG. 5 is a flowchart of a block data processing method according to an embodiment of this application.

FIG. 6 is a schematic structural diagram showing configuration information of a shadow node according to an embodiment of this application.

FIG. 7 is a diagram showing exemplary configuration information of a shadow node according to an embodiment of this application.

FIG. 8A is a flowchart of another block data processing method according to an embodiment of this application.

FIG. 8B is a flowchart showing a proposal stage of a shadow node according to an embodiment of this application.

FIG. 9 is a flowchart showing a proposal stage of a service node of a to-be-processed service object according to an embodiment of this application.

FIG. 10 is a flowchart showing consensus in a case that a service node of a to-be-processed service object is a proposal node according to an embodiment of this application.

FIG. 11 is a flowchart showing a prevoting stage of a shadow node according to an embodiment of this application.

FIG. 12 is a flowchart showing a precommitment stage of a shadow node according to an embodiment of this application.

FIG. 13 is a flowchart showing overall consensus processing performed by a shadow node according to an embodiment of this application.

FIG. 14 is a schematic diagram showing modularization of a block data processing apparatus according to an embodiment of this application.

FIG. 15 is a schematic structural diagram of an electronic device according to an embodiment of this application.

### DESCRIPTION OF EMBODIMENTS

To make the objectives, technical solutions, and advantages of this application clearer, the following further describes this application in detail with reference to the accompanying drawings and the embodiments. The specific embodiments described herein are merely used to explain this application but are not intended to limit this application.

In the following descriptions, “some embodiments” involved describe a subset of all possible embodiments. However, “some embodiments” may be the same subset or different subsets of all possible embodiments, and may be combined with each other without conflict.

Unless otherwise defined, meanings of all technical and scientific terms used herein are the same as those usually understood by a person skilled in the art to which this application belongs. Terms used herein are merely intended to describe the embodiments of this application, but are not intended to limit this application.

Before the embodiments of this application are further described in detail, a description is made on nouns and terms in the embodiments of this application, and the nouns and terms in the embodiments of this application are applicable to the following explanations.

Blockchain is a new application mode of computer technologies such as distributed data storage, point-to-point transmission, consensus mechanisms, and encryption algorithms. A blockchain is essentially a decentralized database, and is a string of data blocks generated in a cryptographic manner. Each data block includes information about a batch of network transactions, which is configured to verify validity of the information (anti-counterfeiting) and generate a next block. A blockchain may include a blockchain bottom platform, a platform product service layer, and an application service layer. Blockchains may include public chains, consortium chains, and private chains, where the public chains refer to blockchains where anyone can access the blockchain network at any time to read data, transmit data, or contend for bookkeeping; the consortium chains refer to blockchains jointly managed by several organizations or institutions; the private chains refer to blockchains with a certain degree of centralized control, where the writing right of a ledger of each private chain is controlled by an organization or institution, and the access and use of data are subject to strict permission management.

Block: it is a data packet that carries transaction data (i.e., transaction services) on the blockchain network and is a data structure marked with a timestamp and a hash value corresponding to a previous block. The transaction in the block is verified and determined through the consensus mechanism of the network.

Block height: it is configured for identifying the number of blocks connected to the blockchain, and may be configured for determining the position of a block in the blockchain.

Based on this, feature concepts possibly involved in this application will be explained and described.

Consensus algorithm: it is a specification followed by all blockchain nodes, and is a series of processes and rules generated to achieve distributed consistency protocols. After nodes distributed in different regions negotiate and interact according to this set of rules, a consistent decision can always be reached on one or some issues, thus achieving consistency among different nodes in a distributed system.

TBFT algorithm: i.e., Tendermint BFT consensus algorithm, which is a Byzantine fault-tolerant consensus algorithm that supports nodes that meet a 3f+1 rule, where f represents the allowed number of malicious nodes in the entire network. In a case that the number of malicious nodes exceeds the allowed number, it will result in a decrease in the security of the entire network, or even make the entire network unusable.

Consensus nodes: also known as verification nodes, which are nodes in the blockchain that perform consensus processing on blocks generated by leader nodes, are nodes responsible for verifying transactions and generating new blocks in the blockchain network, and need to reach a unanimous decision through the consensus algorithm.

Proposal: it is a request or proposal transmitted by a service node of a to-be-processed service object (also referred to as a “target service object”) to verification nodes for consensus processing on a certain block.

Based on the theoretical foundation mentioned above, as well as the research and progress of the blockchain technology, the blockchain technology has been studied and applied in a plurality of fields, such as common digital assets, financial asset transaction settlement, deposit certificate anti-counterfeiting, and data services. It is believed that with the development of the technology, the blockchain technology will be applied in more fields and play an increasingly important role.

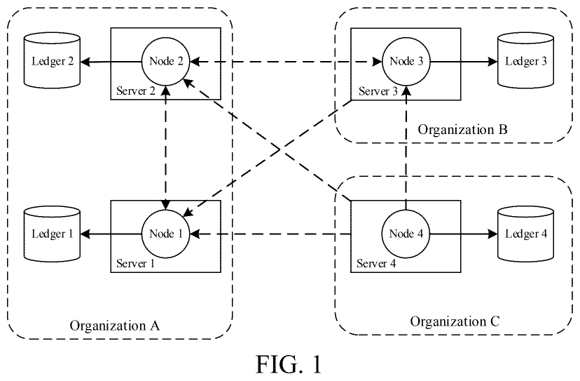

With the continuous development of computer networks, the related technologies of blockchains have become increasingly mature. Blockchain is a new application mode of computer technologies such as distributed data storage, point-to-point transmission, consensus mechanisms, and encryption algorithms. Considering that information stored on a blockchain cannot be forged or tampered with, more and more enterprises will build service nodes on the blockchain to store service data on corresponding service nodes and achieve management of service data. However, for some service systems, due to the varying importance of their service nature, different service systems have different weights in the same blockchain, i.e., the voting values in the blockchain are higher. In this case, for service systems with higher weights, it is needed to deploy a corresponding number of consensus nodes on the blockchain. For example, referring to FIG. 1, assuming that the entire blockchain network includes three service systems as participants, in a case that participant A wishes to have a higher proportion of discourse power, it needs to deploy more consensus nodes. For example, for participants A, B, and C, when participant A requires higher discourse power, 2 consensus nodes may be deployed for participant A, and 1 consensus node may be deployed for each of participant B and participant C. At this time, participant A has 2 consensus nodes and has higher discourse power for voting transactions initiated in the blockchain.

However, since each consensus node needs to store a ledger, for participants who require higher discourse power, having more consensus nodes also means occupying more resources, such as CPU resources and storage resources, resulting in significant resource consumption.

For this reason, solutions provided in embodiments of this application involve technologies such as blockchain. Through the shadow node in the service node group, proposal processing, block locking processing, or block commitment processing is performed according to the instruction of the service node of the to-be-processed service object. In addition, the shadow node does not need to store relevant ledger data of the blockchain network. At the same time, the shadow node can perform processing behavior consistent with or default to that of the service node of the to-be-processed service object, thus effectively reducing the amount of resources occupied by a service object with a high weight proportion, and improving the operation efficiency of the blockchain network.

The block data processing method according to the embodiment of this application can be applied to any electronic device with data processing and computing capabilities. The electronic device may be any terminal or server. The terminal and the server are connected through a communication network. A server is a node server in the blockchain network. A plurality of servers form the blockchain network. In a case that the electronic device in the embodiment of this application is a server, the server is an independent physical server, or a server cluster or distributed system composed of a plurality of physical servers, or a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In some embodiments, the terminal is, but not limited to, a smart phone, a tablet, a laptop, and a desktop computer.

The terminal involved in the embodiment of this application may include, but not limited to, a mobile phone, a computer, an intelligent voice interaction device, a smart household electrical appliance, a vehicle-mounted terminal, and an aircraft. The embodiment of this application may be applied to various scenarios, including but not limited to cloud technology, artificial intelligence, smart transportation, and assisted driving.

In some possible implementations, a computer program capable of implementing the block data processing method according to the embodiment of this application may be deployed and executed on one electronic device, or executed on a plurality of electronic devices located at one place, or executed on a plurality of electronic devices distributed at a plurality of places and interconnected through a communication network. The plurality of electronic devices distributed at a plurality of places and interconnected through the communication network can form a blockchain system.

A blockchain system can be formed based on a plurality of electronic devices. The electronic device implementing the block data processing method in the embodiment of this application may be a node in the blockchain system. This node has a computer program stored therein that can execute the block data processing method. The computer program first constructs a service node group including a service node of a to-be-processed service object and at least one shadow node based on a voting right need of the to-be-processed service object, so that the shadow node performs proposal processing, block locking processing, or block commitment processing according to an instruction of the service node of the to-be-processed service object In addition, in the embodiment of this application, the shadow node does not store the relevant ledger data of the blockchain network, and only needs to perform a processing behavior consistent with or default to that of the service node of the to-be-processed service object, thus reducing the amount of resources occupied by a service object with a high weight proportion, and improving the operation efficiency of the blockchain network.

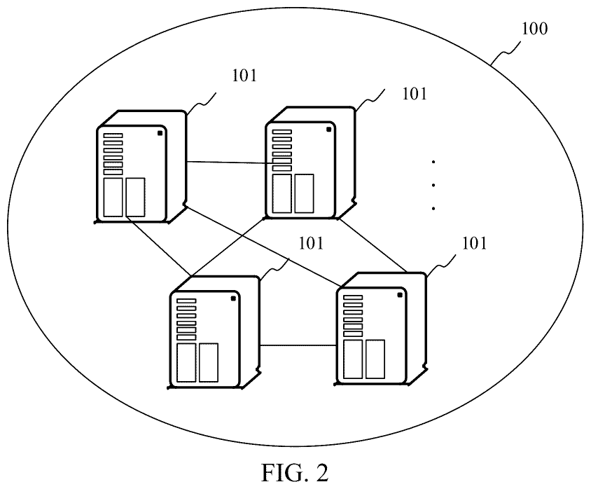

FIG. 2 is a schematic diagram showing an implementation environment according to an embodiment of this application. Referring to FIG. 2, the implementation environment includes a plurality of nodes 101. The plurality of nodes 101 refer to various terminals or servers in a data processing system 100, including computers, mobile phones, tablets, other terminals, backend servers for this program logic, or cloud servers that provide cloud computing and cloud storage services. The node 101 may also be referred to as a service node or a consensus node. During normal operation, each node 101 may receive input information and maintain shared data in the data processing system 100 based on the received input information. In order to ensure information exchange in the data processing system 100, there may be information connections between the nodes in the data processing system 100, and information may be transmitted between the nodes through the information connections. For example, in a case that any node in the data processing system 100 receives input information, other nodes in the data processing system 100 will obtain the input information according to a consensus algorithm and store it as data in the shared data, so that the data stored on all nodes in the data processing system 100 are consistent. The relevant node 101 may construct a service node group including a service node of the to-be-processed service object and at least one shadow node according to the voting right need of the to-be-processed service object. The constructed shadow node may be directly applied to downstream tasks for relevant block consensus operations (including, but not limited to, proposal processing, block locking processing, or block commitment processing).

Exemplarily, the node 101 first obtain a voting right need of a to-be-processed service object, and then constructs a service node group according to the voting right need of the to-be-processed service object, where the service node group includes a service node of the to-be-processed service object and at least one shadow node. Then, the shadow node may perform the following processing: a. extracting, in response to proposal information transmitted by a service node of a to-be-processed service object, block information from the proposal information, performing proposal processing, and generating a proposal notification, b. extracting, in response to block locking voting information transmitted by the service node of the to-be-processed service object, first voting content from the block locking voting information, and performing block locking processing on the proposal notification; and c. extracting, in response to block commitment voting information transmitted by the service node of the to-be-processed service object, second voting content from the block commitment voting information, and performing block commitment processing to complete consensus on the block information. In this way, the shadow node in the service node group constructed in the embodiment of this application can achieve the same proposal or consensus function as ordinary nodes without occupying ledger storage resources, meet the voting right need of any service object, and improve the operation efficiency of the blockchain network by reducing the resource occupation rate.

The block data processing method may be applied to various scenarios.

For example, in a scenario where the to-be-processed service object performs consensus voting, in a case that authorization of the to-be-processed service object is obtained, a service node group is constructed in the node 101 of the to-be-processed service object according to the voting right need of the to-be-processed service object. Correspondingly, the service node group includes a service node of the to-be-processed service object and at least one shadow node. The number of the shadow node is set according to the voting right need of the to-be-processed service object. The shadow nodes in the service node group can perform proposal processing, block locking processing, or block commitment processing according to an instruction of the service node of the to-be-processed service object. In addition, the shadow node does not store the relevant ledger data of the blockchain network, but only needs to perform a processing behavior consistent with or default to that of the service node of the to-be-processed service object, thus keeping the processing behavior of the shadow node consistent with the processing behavior of the service node of the to-be-processed service object, increasing the voting weight of the service node of the to-be-processed service object, and meeting the voting right need of the to-be-processed service object. In addition, the shadow node occupies fewer resources, thus effectively improving the operation efficiency of the blockchain network. The above application scenario only serves as an example. In practical application, in addition to the server configured to perform the above data processing process, other devices with data processing capabilities such as terminals may also be configured to construct the service node group and performing the related service processing process. Besides, other devices in addition to terminal devices may also be configured to carry the completed service node group. The application scenario of the block data processing method according to the embodiment of this application is not limited here in any way.

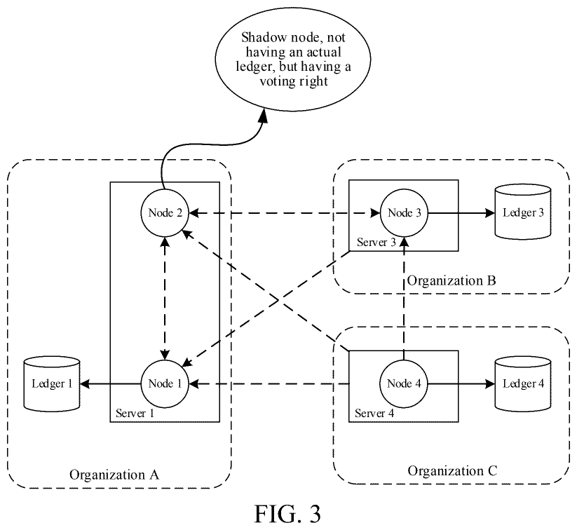

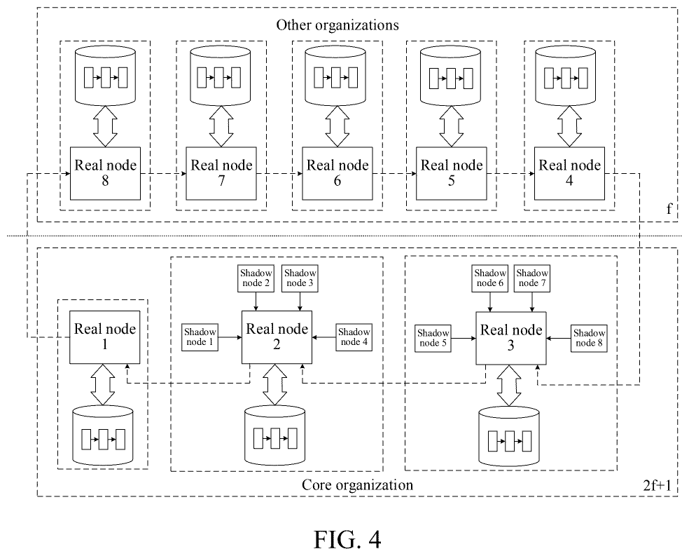

Based on the implementation environment shown in FIG. 2, an embodiment of this application provides an application scenario for consensus node weight allocation. In this scenario, there are information connections between nodes, and information may be transmitted between the nodes through the information connections. The node may construct a service node group for a target application to increase its weight proportion in the node network. For example, referring to FIG. 3, in a four-node network, according to the voting right need of the to-be-processed service object, the weight proportion of its corresponding node is required to be 50%. Therefore, a service node group including one service node (Node 1) of the to-be-processed service object and one shadow node (Node 2) is constructed, so as to achieve weight allocation to consensus nodes. In addition, the shadow nodes does not store relevant ledger data in the blockchain network, but only performs a processing behavior consistent with or default to that of the service node of the to-be-processed service object, i.e., Node 2 does not have an actual ledger, but has a voting right, thus meeting the voting right need of any service object, reducing the amount of resources occupied by a service object with a high weight proportion, and improving the operation efficiency of the blockchain network. Exemplarily, the target application may be an application platform for resource allocation, as well as web link, mini program, or application plugin with a service function such as transaction validity verification or shared state update set in a multimedia application (such as film and television application, short video application, or music application), a social application, a gaming application, or a navigation application. For example, in an actual service system, its deployment situation may be as shown in FIG. 4, where each real node may serve as the service node of the to-be-processed service object corresponding to the shadow node, i.e., the service node of the to-be-processed service object.

In various specific implementations of this application, in a case that it involves obtaining data such as feature data, behavior data, historical data, and location information of the object related to the identity or characteristics of the object for relevant processing, permission or authorization from the object will be obtained first, and the collection, use, processing and the like of these data will comply with relevant laws, regulations, and standards. In addition, in a case that the embodiment of this application needs to obtain sensitive personal information of the object, separate permission or consent of the object will be obtained through a pop-up or by jumping to a confirmation page. After the separate permission or consent of the object is obtained, needed object related data for the normal operation in the embodiment of this application are obtained.

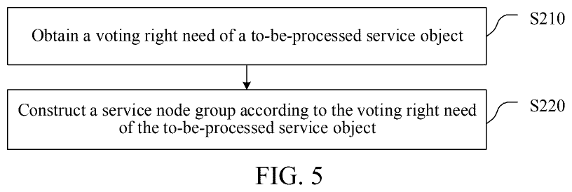

FIG. 5 is a flowchart of a block data processing method according to an embodiment of this application. The executing entity of the block data processing method may be any electronic device described above. Referring to FIG. 5, the method includes the following operations:
S210: obtain a voting right need of a to-be-processed service object.
S220: construct a service node group according to the voting right need of the to-be-processed service object.

The service node group includes a service node of the to-be-processed service object and at least one shadow node of the service node. The service node of the to-be-processed service object is configured to perform block data processing according to stored block ledger data; and the block data processing performed by the shadow node is kept consistent with the block data processing performed by the service node of the to-be-processed service object, and the shadow node does not store the block ledger data for the block data processing.

In the embodiment of this application, the to-be-processed service object refers to a participant or an organization in a certain service application, such as an enterprise, a related institution, a group, and any other entity participating in the blockchain service network. In the embodiment of this application, the voting right, i.e., voting weight, refers to the permission held by each node in the voting process. Correspondingly, the voting right need in the embodiment of this application refers to the expected permission of the service node of the corresponding to-be-processed service object, i.e., the voting weight value that the service node needs to take.

In the embodiment of this application, the shadow node only performs relevant consensus service processing, such as proposal processing, block locking processing, or block commitment processing based on the instruction of the service node of the to-be-processed service object, thus keeping the processing behavior of the shadow node consistent with the processing behavior of the service node of the to-be-processed service object, improving the voting weight of the service node of the to-be-processed service object, and meeting the voting right need of the to-be-processed service object. In addition, the shadow node does not store relevant ledger data in the blockchain network, thus effectively reducing the amount of resources occupied by the shadow node and improving the operation efficiency of the blockchain network.

Specifically, in the embodiment of this application, the service node group constructed according to the voting right need of the to-be-processed service object includes a service node of the to-be-processed service object and at least one shadow node. The service node of the to-be-processed service object is a real node of the to-be-processed service object and may serve as a host node. Therefore, the service node of the to-be-processed service object may also be called a host node, and the block ledger data are stored in the host node. In the embodiment of this application, the number of the shadow nodes of the service node may be adjusted specifically according to the voting right need. Exemplarily, taking a network security application scenario as an example, in the embodiment of this application, a corresponding service node group is constructed first based on a voting right need of each network security node. For example, a certain network security node with high credibility has a higher weight in a network security verification process, so that its voting result has a greater influence, thus improving the security of the network. Therefore, in the embodiment of this application, the number of the shadow nodes included in the corresponding service node group is determined based on the voting right need of the relevant network security node, so as to construct a service node group that meets the voting right need of the network security node. Correspondingly, in the embodiment of this application, the shadow node performs relevant service processing according to the instruction of the service node of the to-be-processed service object, so as to keep the processing behavior consistent with the processing behavior of the service node of the to-be-processed service object, thus increasing the voting weight of the service node of the to-be-processed service object, i.e., increasing the voting influence of the corresponding network security node.

In order to effectively improve the voting weight of the to-be-processed service object and meet the voting right need of any service object, in some feasible embodiments, the operation of constructing a service node group based on the voting right need of the to-be-processed service object may include, but not limited to, S310 to S320:
S310: configure one or more shadow nodes for the service node of the to-be-processed service object according to the voting right need of the to-be-processed service object.

In the embodiment of this application, the service node of the to-be-processed service object is a real node, i.e., is a host node of the shadow node, and the service node of the to-be-processed service object will store the relevant block ledger data in the blockchain network. Correspondingly, in the embodiment of this application, the shadow node does not have actual block ledger data, i.e., the shadow node does not store relevant block ledger data in the blockchain network. However, the shadow node has the voting right like the ordinary node, which means that other nodes can receive the voting information transmitted by the shadow node since the shadow node has the voting right. Therefore, other nodes cannot perceive that the node is a shadow node and do not know that the shadow node does not store the block ledger data. In the embodiment of this application, by analyzing the voting need of the to-be-processed service object, one or more shadow nodes are configured for the service node of the to-be-processed service object, thus meeting the voting right need of any service object.

Exemplarily, taking an application scenario with four to-be-processed service objects as an example, each to-be-processed service object corresponds to one service node. Therefore, the voting weight of the service node of each to-be-processed service object is 25%. In a case that a to-be-processed service object A needs to reach a voting weight of 40%, in the embodiment of this application, a shadow node is configured for the corresponding node of the to-be-processed service object, i.e., the service node of the to-be-processed service object, based on the voting right need of the to-be-processed service object, i.e., the voting weight proportion of 40%. After a shadow node is configured for the service node of the to-be-processed service object, there are five nodes in the network, the nodes of other to-be-processed service objects cannot perceive that the configured node is a shadow node, the shadow node also has the voting right, and the processing behavior of the shadow node is consistent with the processing behavior of the service node of the to-be-processed service object, thus increasing the voting weight of the to-be-processed service object A to 40%. Correspondingly, in the embodiment of this application, by configuring a corresponding number of shadow nodes for the service node of the to-be-processed service object with a different voting right need, the voting weight of the to-be-processed service object can be effectively increased, thus meeting the voting right need of any service object.
S320: perform initial information configuration on each shadow node, and combine the one or more configured shadow nodes with the service node of the to-be-processed service object to obtain a service node group.

In the embodiment of this application, the initial information configuration refers to the relevant node configuration information of the shadow node, such as the identifier, network address, security settings, and other configuration information of the shadow node. In the embodiment of this application, after configuring the corresponding number of shadow nodes for the service node of the to-be-processed service object based on the voting right need of the to-be-processed service object, initial information configuration is performed on each shadow node, and then a configured shadow node is combined with the service node of the to-be-processed service object to obtain a service node group. For example, two shadow nodes are configured for the corresponding service node according to the voting right need of the to-be-processed service object. Next, in the embodiment of this application, initialization is first performed on the two shadow nodes respectively, i.e., initial information configuration, such as configuration of the relevant identifier, consensus algorithm parameters, network address, and other related node information parameters, is performed. After the relevant initialization information configuration is completed, the shadow node is equivalent to an ordinary node to the outside world. Except for the corresponding service node of the to-be-processed service object that can perceive that it is a shadow node, other nodes recognize it as a normal node. Next, in the embodiment of this application, the two shadow nodes that have been configured are combined with the corresponding service node of the to-be-processed service object to construct a service node combination that meets the voting right need of the relevant to-be-processed service object.

In order to ensure that the shadow node can perform a processing behavior consistent with the processing behavior of the service node of the to-be-processed service object and can perform relevant processing behavior, in some feasible embodiments, the operation of performing initial information configuration on each shadow node may include, but not limited to, S410 to S430:
S410: configure node mapping information between the shadow node and the service node of the to-be-processed service object, the node mapping information representing an association relationship between each shadow node and a corresponding service node of the to-be-processed service object.

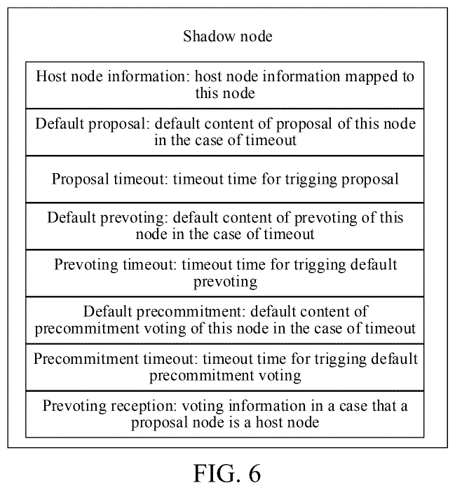

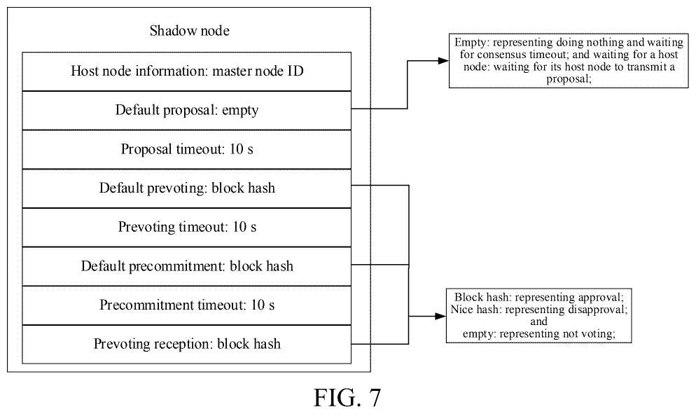

In the embodiment of this application, the node mapping information refers to the mapping information between the shadow node and its corresponding service node of the to-be-processed service object, i.e., the real node information mapped by the shadow node. In the embodiment of this application, the association relationship refers to the corresponding relationship between the shadow node and the service node of the to-be-processed service object. In the embodiment of this application, the node mapping information represents an association relationship between each shadow node and the corresponding service node of the to-be-processed service object. In the embodiment of this application, by configuring the node mapping information between the shadow node and the service node of the to-be-processed service object, a corresponding relationship between the service node of the to-be-processed service object and the shadow node is constructed, so that the shadow node can receive an instruction from the service node of the to-be-processed service object and keep the processing behavior consistent with the processing behavior of the service node of the to-be-processed service object. For example, as shown in FIG. 6 and FIG. 7, after a corresponding number of shadow nodes are configured for the service node of the to-be-processed service object based on the voting right need of the to-be-processed service object, in the embodiment of this application, node mapping information is configured for each shadow node to associate the corresponding service node of the to-be-processed service object, so that the shadow nodes can perform the relevant processing behavior according to the instruction of the service node of the to-be-processed service object.
S420: configure default operation information of the shadow node, the default operation information being configured for indicating a processing action to be taken by the shadow node in the case of not receiving an instruction transmitted by the service node of the to-be-processed service object.

In the embodiment of this application, the default operation information refers to information about the relevant processing action performed by the shadow node in the case of not receiving the instruction transmitted by the corresponding service node of the to-be-processed service object. Due to reasons such as data transmission errors, in some cases, the shadow node may not receive the instruction from the service node of the to-be-processed service object, or the service node of the to-be-processed service object may fail to transmit the relevant instruction to the shadow node in time. In this case, the shadow node needs to perform a relevant default operation to complete the node consensus process. Specifically, as shown in FIG. 6 and FIG. 7, in the embodiment of this application, the configured default operation information includes default content of proposal, default content of prevoting, and default content of precommitment.

The default operation information mentioned in the embodiment of this application may be adaptively configured according to the need of the service node of the to-be-processed service object. For example, for prevoting information transmitted by the service node of the to-be-processed service object, it may be set as default approval, and for prevoting information transmitted by a service node of a non-to-be-processed service object, it may be set as default disapproval, which are not limited in the embodiment of this application. Exemplarily, in a resource allocation application scenario, results of node voting may influence the allocation of assets or rewards. Therefore, consensus node voting weight allocation may also be configured for determining an allocation mode of resources, so as to ensure that participating nodes receive appropriate returns based on their contributions or benefits. Correspondingly, after a corresponding number of shadow nodes are configured for the service node of the to-be-processed service object according to the voting right need of the to-be-processed service object, in the embodiment of this application, corresponding default operation information is configured for each shadow node to alleviate the problem that the shadow node cannot perform relevant node consensus processing in the case of not receiving the instruction transmitted by the service node of the to-be-processed service object.

In the embodiment of this application, by configuring corresponding default content of proposal, prevoting, and precommitment stages for each shadow node, the shadow node can take a corresponding processing action according to the corresponding default content in each stage of node consensus in a case that the shadow node does not receive the instruction from the service node of the to-be-processed service object, thus completing the entire node consensus process and ensuring that other nodes cannot perceive that the node is a shadow node.
S430: configure response timeout information of the shadow node.

In the embodiment of this application, response timeout refers to exceeding specified time, failing to receive information, or not receiving corresponding information. Correspondingly, the response timeout information refers to response timeout time of the shadow node in each stage of node consensus. In the embodiment of this application, corresponding response timeout information is configured for each shadow node, so that the shadow nodes can perform a corresponding processing action based on the preconfigured default operation information after response timeout. Exemplarily, as shown in FIG. 6 and FIG. 7, in a scenario of initial information configuration of a shadow node, the response timeout information configured in the embodiment of this application includes timeout time for triggering a proposal, timeout time for triggering prevoting, and timeout time for triggering precommitment. In the embodiment of this application, relevant timeout information is configured for each shadow node, so that the shadow node can take a corresponding processing action in time according to the preconfigured default operation information in the case of not receiving the instruction transmitted by the service node of the to-be-processed service object within the specified time, i.e., response timeout, thus effectively improving the operation efficiency of the blockchain network.

Based on the introduction of the method for constructing the service node group described above, an embodiment of this application further provides a block data processing method for a blockchain network. The blockchain network includes a plurality of nodes. The method is configured for configuring a shadow node for a service node. The method includes:
determining a service node of a to-be-processed service object from the plurality of nodes of the blockchain network;
calculating a number of shadow nodes to be configured for the service node of the to-be-processed service object according to a voting right weight expected by the service node of the to-be-processed service object and a number of nodes of the blockchain network; and
configuring shadow nodes for the service node of the to-be-processed service object according to the number of shadow nodes.

The block data processing performed by the shadow node is kept consistent with the block data processing performed by the target service node, and the shadow node does not store the block ledger data for the block data processing.

In a case that the voting right need in S310 is the voting weight expected by the service node of the to-be-processed service object, this method may be a specific implementation of S310.

In a possible implementation, the method for configuring the shadow node for the service node of the to-be-processed service object according to the number of shadow nodes may include configuring node mapping information between the shadow node and the service node of the to-be-processed service object, the node mapping information representing an association relationship between each shadow node and the service node of the to-be-processed service object; configuring default operation information of the shadow node, the default operation information being configured for indicating a processing action to be taken by the shadow node in the case of not receiving an instruction transmitted by the service node of the to-be-processed service object; and configuring response timeout information of the shadow node. For details, a reference may be made to S410 to S430, which will not be repeated here.

In the embodiment of this application, a blockchain network is constructed in a specific service scenario. This blockchain network includes a plurality of nodes, including service nodes of to-be-processed service objects with high importance. According to some specific service scenario requirements, the service node of the to-be-processed service object needs to obtain a higher voting weight. Therefore, in the embodiment of this application, the number of shadow nodes to be configured may be calculated according to the voting weight expected by the service node of the to-be-processed service object, and then shadow nodes are configured for the service node of the to-be-processed service object. Exemplarily, for a blockchain network with three nodes, assuming that a certain participant (i.e., the service node of the to-be-processed service object) wishes to occupy a permission of 50%, it only needs to deploy one shadow node. In this case, the entire blockchain network contains four nodes with voting rights, and the combination of the service node of the to-be-processed service object and the shadow node results in a voting weight of 50%, thus reaching the voting weight expected by the service node of the to-be-processed service object. To sum up, in the embodiment of this application, the shadow node does not need to store the relevant ledger data of the blockchain network, and can perform a processing behavior consistent with or default to that of the service node of the to-be-processed service object, thus reducing the amount of resources occupied by a service object with a high weight proportion, and improving the operation efficiency of the blockchain network.

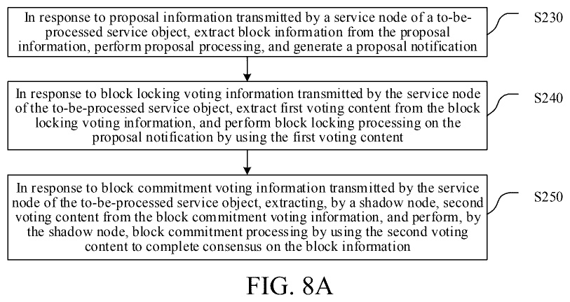

After the service node group of the to-be-processed service object is constructed based on the above method, when it is required to process block data, block data processing may be performed based on the constructed service node group of the to-be-processed service object. This block data processing method may be executed by a shadow node. The shadow node may be an electronic device, such as a server or a terminal, which is not limited in the embodiment of this application. Referring to FIG. 8A, the method includes the following operations:
S230: extract, in response to proposal information transmitted by a service node of a to-be-processed service object, block information from the proposal information, perform proposal processing, and generate a proposal notification.

The proposal notification is configured for triggering each node to perform block locking processing. The service node of the to-be-processed service object and the shadow node are located in a service node group of the to-be-processed service object. The service node group of the to-be-processed service object is constructed based on the method introduced in the above embodiment.

In the embodiment of this application, the proposal information refers to the content proposed by the relevant node for consensus among all nodes, so as to wait for relevant information about consensus among all nodes. In the embodiment of this application, the proposal information of the shadow node in the service node group is provided by the service node of the to-be-processed service object, i.e., the shadow node first obtain the corresponding proposal information from the service node of the to-be-processed service object before initiating the proposal, so as to keep the processing behavior consistent with the processing behavior of the service node of the to-be-processed service object. The shadow node may receive proposal information transmitted by the service node of the to-be-processed service object in real time within a preset waiting time range. This proposal information may directly transmit an instruction to the shadow node to require it to perform corresponding proposal processing, i.e., the proposal processing performed by the shadow node can be kept consistent with the processing behavior of the service node of the to-be-processed service object. In addition, when performing the corresponding proposal processing, the shadow node does not need to perform corresponding calculation based on the block ledger data stored in its own node like other ordinary nodes to obtain an operation result of the proposal processing. Therefore, in the embodiment of this application, the shadow node can help the service node of the to-be-processed service object to increase the voting weight.

In the embodiment of this application, the block information refers to all transaction records, block headers, and other related information contained in a block. When a relevant node proposes a new block, other nodes need to verify its validity based on the block information and vote to decide whether to accept this block. In the embodiment of this application, the proposal refers to a process in which a relevant consensus node proposes a proposal in a blockchain network and notifies other nodes to discuss and vote. Correspondingly, the proposal notification refers to notification information about that a relevant consensus node proposes a new rule, protocol, or improvement plan, and notifies other nodes to discuss and vote, so as to decide whether to accept the proposal. In the embodiment of this application, the shadow node extracts corresponding block information from the proposal information transmitted by the service node of the to-be-processed service object, performs proposal processing, generates a relevant proposal notification, and transmits to each node, thus triggering each node to perform block locking processing. Block locking refers to a process that after a node receives a prevoting set for a block that exceeds a certain proportion of the total number of nodes (such as a prevoting set that exceeds ⅔ of the total number of nodes) at a specific height and round, this node locks this block at that height and round, so as to indicate approval on the block by locking the block. Exemplarily, taking a digital financial asset transaction validity verification scenario as an example, when a target object initiates a digital financial asset transaction, it is required to verify the validity of the digital financial asset transaction. In the embodiment of this application, proposal information is first transmitted to a corresponding shadow node through a service node of a corresponding service node group. Then, the corresponding shadow node extracts, in response to the proposal information, relevant block information from the proposal information, and performs relevant proposal processing to obtain a proposal notification. Next, the shadow node transmits the generated proposal notification to each node, so that each node performs voting on the digital financial asset transaction to determine whether the digital financial asset transaction is valid, i.e., each node is triggered to perform block locking processing.
S240: extract, in response to block locking voting information transmitted by the service node of the to-be-processed service object, first voting content from the block locking voting information, and perform block locking processing on the proposal notification by using the first voting content.

In the embodiment of this application, the block locking voting information refers to information about that the service node of the to-be-processed service object in the blockchain network performs voting on a locking state of a certain block. Correspondingly, the locking state usually refers to whether the block has been confirmed as valid by other nodes and cannot be modified or deleted anymore. In the embodiment of this application, the first voting content refers to block locking state information extracted from the block locking voting information transmitted by the service node of the to-be-processed service object and configured for performing block locking on the relevant block, so as to confirm whether the node is valid or invalid, for example. Exemplarily, taking a blockchain election application scenario as an example, in a blockchain voting election process, different voting weights need to be allocated to different voters to ensure the fairness and effectiveness of voting. For example, voting weights are allocated based on the identities and rights of different to-be-processed service objects to ensure the fairness and transparency of election. Therefore, in the embodiment of this application, a service node group is first constructed according to a voting right need of a corresponding election voting object. Then, in a case that the service node group receives proposal notifications initiated by other nodes, a service node of the to-be-processed service object in the service node group transmits block locking voting information to a shadow node, the shadow node extracts voting information for a certain elected object according to the block locking voting information, i.e., first voting content, so as to perform corresponding block locking processing on the received proposal notification according to the first voting content, so that the processing behavior of the shadow node is consistent with the processing behavior of the service node of the to-be-processed service object, thus increasing the voting weight of the service node of the to-be-processed service object, i.e., increasing the voting influence of the corresponding election voting object.
S250: extracting, by the shadow node, in response to block commitment voting information transmitted by the service node of the to-be-processed service object, second voting content from the block commitment voting information, and performing, by the shadow node, block commitment processing by using the second voting content to complete consensus on the block information.

The second voting content includes a result of the block locking processing performed by each node.

In the embodiment of this application, the block commitment voting information refers to voting information about block commitment in a case that a locked block exists in the relevant node. In the blockchain, in order to ensure the validity and consistency of each block, consensus nodes need to perform voting on the locking state of a certain block to determine whether this block can be confirmed as a valid block. Correspondingly, the voting information of the consensus nodes will be recorded on the blockchain, so that other nodes can verify the validity and consistency of the block. In the embodiment of this application, the second voting content includes a result of the block locking processing performed by each node. In the embodiment of this application, the block voting information committed by the shadow node is extracted from the block voting information transmitted by the service node of the to-be-processed service object, and consensus on block information is completed according to the extracted block locking processing result of each node, so that the voting behavior of the shadow node is kept consistent with that of the service node of the to-be-processed service object. Exemplarily, taking a blockchain shared state application scenario as an example, in a case that changes occur in protocols or rules related to the blockchain, nodes may decide whether to accept these changes by voting and update the state of the blockchain. In a case that the relevant to-be-processed service object receives a protocol modification proposal from a certain node, the to-be-processed service object transmits block commitment voting information to the shadow node through the service node of the to-be-processed service object in the service node group, so as to instruct the shadow node to perform relevant block voting processing. In the embodiment of this application, the block voting information of the service node of the to-be-processed service object is obtained from the block locking processing result of each node. Correspondingly, in the embodiment of this application, the shadow node extracts the block locking result of each node according to the received block voting information to perform block commitment processing, thus keeping the processing behavior of the shadow node on the relevant proposal consistent with that of the service node of the to-be-processed service object to complete consensus on block information.

In order to ensure that the shadow node can perform proposal processing and achieve a complete node consensus process without storing relevant ledger data in the blockchain network, in some feasible embodiments, the operation of extracting, by the shallow node, in response to proposal information transmitted by a service node of a to-be-processed service object, block information from the proposal information, performing proposal processing, and generating a proposal notification may include, but not limited to, S510 to S520:
S510: in a case that the shadow node becomes a proposal node, receive proposal information of the service node of the to-be-processed service object in real time within a preset waiting time range.

In the embodiment of this application, the proposal node, also known as a proposer, refers to a node that proposes to perform a setting operation on a certain value, where the behavior of setting a value is called a proposal, such as a node that proposes a new transaction or block. The proposal node needs to obtain votes from other nodes in order to make the proposal take effect. In the embodiment of this application, the preset waiting time is the response timeout time of the shadow node, i.e., in a case that the proposal information of the service node of the to-be-processed service object is not received within the preset waiting time, a response timeout occurs. Specifically, in a case that a shadow node needs to initiate a proposal, i.e., the shadow node becomes a current proposal node, since the shadow node does not store relevant block ledger data in the blockchain network, it needs to receive proposal information from the corresponding service node of the to-be-processed service object to generate a corresponding proposal notification. At the same time, in order to alleviate the problem that the proposal process cannot be completed since the proposal information from the service node of the to-be-processed service object is not received, in the embodiment of this application, corresponding preset waiting time is set, and the shadow node receives the proposal information of the service node of the to-be-processed service object in real time within the preset waiting time range. In a case that the proposal information of the service node of the to-be-processed service object cannot be received within the preset waiting time range, the shadow node will perform a corresponding response timeout operation.

Exemplarily, in a blockchain project application scenario, different nodes may have different interests and perspectives. In order to achieve blockchain governance and decision making, in the embodiment of this application, corresponding service node groups are constructed according to the voting right needs of different to-be-processed service objects, so as to achieve governance and decision making by means of consensus node voting weight allocation. Correspondingly, in a case that the shadow node in the service node group become a proposal node, since it cannot generate corresponding proposal information on its own because it does not store relevant block ledger data, in the embodiment of this application, the service node of the to-be-processed service object associated with the shadow node generates the corresponding proposal information and transmits it to the corresponding shadow node. At the same time, the shadow node receives the proposal information of the service node of the to-be-processed service object in real time within the preset waiting time range, so as to perform subsequent proposal operation according to the received proposal information, thus achieving the complete proposal process and making other nodes unable to perceive that it is a shadow node.
S520: in a case that the proposal information of the service node of the to-be-processed service object is received, extract block information from the proposal information, synthesize the block information to obtain a secondary proposal of the shadow node, and then generate a proposal notification.

In the embodiment of this application, the secondary proposal refers to a proposal made by the shadow node. The shadow node constructs the corresponding proposal content according to the proposal information of the service node of the to-be-processed service object, so as to package the proposal of the service node of the to-be-processed service object into a proposal of the shadow node, i.e., the secondary proposal. In a case that the shadow node receives the proposal information of the service node of the to-be-processed service object within the preset waiting time range, in the embodiment of this application, relevant block information is extracted from the proposal information, and the block information is synthesized to obtain proposal content of the shadow node, i.e., the secondary proposal. Next, in the embodiment of this application, the shadow node generates a corresponding proposal notification according to the secondary proposal obtained through synthesis. Exemplarily, in a blockchain node consensus application scenario, in a case that a shadow node of a certain to-be-processed service object becomes a proposal node, a service node of the to-be-processed service object associated with the shadow node perceives that its corresponding shadow node is a current proposal node, and the service node of the to-be-processed service object generates corresponding proposal information and transmits it to the shadow node i.e., currently the proposal node. In a case that the shadow node receives the proposal information within the preset waiting time range, it extracts relevant block information from the proposal information, such as all transaction records, block headers, and other related information in the block. Next, in the embodiment of this application, the extracted block information is synthesized to obtain a secondary proposal, and a corresponding proposal notification is generated.

After the proposal notification is obtained, the proposal notification may be broadcast to each node. In the embodiment of this application, broadcasting refers to broadcast communication, through which data are transmitted in a broadcast network and all network nodes can receive relevant data information. In the embodiment of this application, the proposal notification is transmitted to each node in the blockchain network through broadcasting, so that other nodes can verify, accept or refuse the proposal. For example, after the shadow node generates the corresponding secondary proposal according to the proposal information of the service node of the to-be-processed service object, a proposal notification is obtained, and the shadow node broadcasts the proposal notification, so that each node can receive the proposal notification, thus completing the proposal process of the shadow node. In the embodiment of this application, by generating the proposal information through the shadow node associated with the service node of the to-be-processed service object, the shadow nodes can complete the node consensus proposal function without storing ledger data, thus not only reducing the amount of resources occupied, but also increasing the voting weight of the to-be-processed service object, and effectively improving the operation efficiency of the blockchain network.

In order to alleviate the problem that the shadow node cannot complete proposal since the shadow node cannot receive the proposal information of the service node of the to-be-processed service object in time, in some feasible embodiments, the block data processing method according to the embodiment of this application may further include S610:
S610: in a case that the proposal information of the service node of the to-be-processed service object is not received within the preset waiting time range, generate a default proposal notification according to default configuration information of the shadow node, and broadcast the proposal notification to each node.

In the embodiment of this application, the default configuration information is default information configured for initialization during the construction of the shadow node, and the default information includes default content for performing the proposal after response timeout. In the embodiment of this application, the preset waiting time is timeout time for triggering proposal. Specifically, in a case that the shadow node as a proposal node does not receive proposal information of its associated service node within the preset waiting time range, in the embodiment of this application, it is considered that a response timeout occurs in receiving the proposal information. In this case, the shadow node performs a corresponding response timeout operation, generates a default proposal notification according to the default configuration information preconfigured in the shadow node, and broadcasts it to each node to complete the proposal function. Exemplarily, taking a digital financial asset application scenario as an example, in a digital financial asset transaction process, it is required to verify the validity and legality of the transaction. Therefore, for some to-be-processed service objects with higher reliability, they require higher discourse power, i.e., higher voting weight. In the embodiment of this application, according to a relevant voting right need, a service node group including a corresponding number of shadow nodes and a service node of a to-be-processed service object is constructed. In a case that a certain shadow node becomes a proposal node, it is required to receive proposal information of the service node of the to-be-processed service object to construct a corresponding secondary proposal and generate a proposal notification. In a case that the shadow node does not receive the proposal information of the service node of the to-be-processed service object within the preset waiting time range, i.e., a response timeout occurs in receiving the proposal information, in order to respond to the proposal in time, the shadow node generates a default proposal notification according to its default configuration information and broadcasts it to each node in the blockchain network, thus alleviating the problem that the shadow node cannot complete proposal since the shadow node cannot receive the proposal information of the service node of the to-be-processed service object.

An example is shown in FIG. 8B, which is a flowchart showing a proposal stage of a shadow node according to an embodiment of this application. After entering a block consensus process at a new height, in the embodiment of this application, the shadow node determines whether it is a proposal node at that height. In the embodiment of this application, height refers to the height of blocks in the blockchain network, i.e., the number of blocks in the blockchain. Correspondingly, since each block contains a hash value of a previous block, the block height may also be understood as the chain length in the blockchain. In addition, in a consensus algorithm of the blockchain, each node needs to verify the validity of a new block by verifying the transaction and hash value in the block, and add it to the blockchain. Therefore, height also represents the synchronization state in the blockchain network, since each node is to have the same block height. In a case that it is determined that it is not a proposal node at that height, the shadow node waits for proposal information of other nodes within certain time. In a case that it is determined that the shadow node itself is a proposal node at that height, the shadow node waits for the corresponding service node of the to-be-processed service object to transmit proposal information to it. At the same time, in a case that the service node of the to-be-processed service object determines that its corresponding shadow node is a proposal node, it generates corresponding proposal information and transmits it to the shadow node to instruct the shadow node to perform proposal processing. After the shadow node receives the proposal information of the service node of the to-be-processed service object, it first verifies the source of the proposal information to determine that it is proposal information from the associated service node of the to-be-processed service object. Next, after verification passes, i.e., it is determined that the proposal information comes from the associated service node of the to-be-processed service object, the shadow node parses the proposal information to obtain the block information therein, generates new proposal information, i.e., a proposal notification, and broadcasts it to each node in the blockchain network. Correspondingly, in a case that it is determined that the proposal information does not come from the associated service node of the to-be-processed service object, the proposal information is discarded. In addition, in a case that the shadow node does not receive the proposal information of the service node of the to-be-processed service object within the preset waiting time range, i.e., a response timeout occurs in receiving the proposal information of the service node of the to-be-processed service object, the shadow node generates default proposal information, i.e., a proposal notification, according to the preconfigured default configuration information, and broadcasts it to each node.

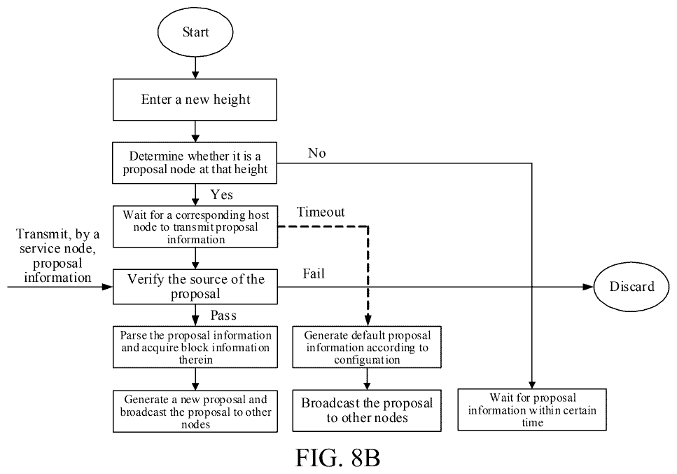

Correspondingly, FIG. 9 shows a flowchart of a proposal stage of a service node of a to-be-processed service object according to an embodiment of this application. First, in the embodiment of this application, before entering the proposal stage, a service node of a to-be-processed service object is first configured. For example, when constructing a service node group, the service node of the to-be-processed service object is configured accordingly, and list information of shadow nodes associated with it, i.e., a shadow node list, is constructed, so as to associate the service node of the to-be-processed service object with the corresponding shadow nodes. Next, after the consensus process reaches a new height, the service node of the to-be-processed service object first determines whether it is a proposal node for that round. In a case that it is determined that it is a proposal node for that round, it generates a corresponding proposal and broadcasts it to other nodes. In a case that it is determined that it is not a proposal node, the service node of the to-be-processed service object further determines whether the shadow node associated with it is a proposal node according to the shadow node list. In a case that it is determined that the shadow node associated with it is a current proposal node, a corresponding proposal is generated and transmitted to the corresponding shadow node, so as to guide the shadow node to propose. On the contrary, in a case that it is determined that the shadow node associated with it is not a proposal node, the service node of the to-be-processed service object waits for other nodes in the blockchain network to transmit proposals.

In order to keep the processing behavior of the shadow node consistent with that of the service node of the to-be-processed service object and achieve block locking processing, in some feasible embodiments, the operation of extracting, by the shadow node, in response to block locking voting information transmitted by the service node of the to-be-processed service object, first voting content from the block locking voting information, and performing block locking processing on the proposal notification may include, but not limited, S710 to S730:
S710: in a case that the shadow node is a proposal node, after broadcasting the proposal notification to each node, receive the block locking voting information of the service node of the to-be-processed service object in real time within the preset waiting time range.

In the embodiment of this application, the preset waiting time range refers to timeout time for triggering prevoting. In the embodiment of this application, the prevoting information of the shadow node is generated by receiving the block voting information of the service node of the to-be-processed service object. Specifically, in a case that the shadow node as a proposal node broadcasts the corresponding proposal notification to each node, the shadow node receives the block locking voting information of the service node of the to-be-processed service object in real time within the preset waiting time range, i.e., in the embodiment of this application, the shadow node obtain the block locking voting information of the proposal from the associated service node of the to-be-processed service object, so as to keep the processing behavior consistent with the processing behavior of the service node of the to-be-processed service object. Exemplarily, in a network security application scenario, nodes corresponding to some to-be-processed service objects may have more voting weight to improve network security. Correspondingly, the to-be-processed service object constructs a service node group according to a corresponding voting right need, and then performs a relevant node consensus process through the service node group. In a case that a shadow node in the service node group becomes a proposal node, the service node of the to-be-processed service object transmits an instruction to the shadow node, so that the shadow node can generate a relevant proposal notification and broadcast it to each node. Further, after broadcasting the proposal notification, the shadow node waits for voting information, i.e., block locking voting information, of the service node of the to-be-processed service object. At the same time, in the embodiment of this application, the shadow node only receives the block locking voting information of the service node of the to-be-processed service object within the preset waiting time range. In a case that the waiting time exceeds the preset waiting time, it performs corresponding response timeout processing.
S720: in a case that the block locking voting information of the service node of the to-be-processed service object is received, extract first voting content from the block locking voting information, synthesize the first voting content to obtain first voting information of the shadow node, and then generate a first voting notification.

In the embodiment of this application, the first voting information is voting information generated by the shadow node for the relevant proposal. In the embodiment of this application, the voting information of the shadow node is generated according to the first voting content extracted from the block locking voting information of the service node of the to-be-processed service object, so that the shadow node can follow the voting of the service node of the to-be-processed service object, thus increasing the voting weight of the service node of the to-be-processed service object. Specifically, in a case that the shadow node receives the block locking voting information of the service node of the to-be-processed service object, in the embodiment of this application, the voting content, i.e., first voting content, of the service node of the to-be-processed service object is extracted from the block locking voting information. Then, the shadow node synthesizes the extracted first voting content, constructs its own voting information, i.e., first voting information, and generates a corresponding first voting notification.

Exemplarily, taking a digital collectible transaction application scenario as an example, in a digital collectible transaction process, consensus verification needs to be performed on the validity of relevant transaction behavior. For some to-be-processed service object nodes with larger rights or higher reliability, they have higher discourse power, i.e., higher voting weight, in the voting verification process. Therefore, in the embodiment of this application, a corresponding service node group is configured, so that the corresponding to-be-processed service object occupies a corresponding voting weight. Correspondingly, in a case that the shadow node in the service node group becomes a proposal node and completes the broadcasting of the corresponding proposal notification, the shadow node receives block locking voting information of the service node of the to-be-processed service object in real time within the preset waiting time range. In a case that the shadow node receives the corresponding block locking voting information within the preset waiting time range, in the embodiment of this application, the voting information of the service node of the to-be-processed service object, such as relevant verification voting information, vote count information, signature information and voting round, is extracted from the block locking voting information. Further, in the embodiment of this application, first voting information corresponding to the shadow node is synthesized by combining the extracted first voting content with the relevant information of the shadow node, thus generating a first voting notification.
S730: broadcast the first voting notification to each node.

In the embodiment of this application, the first voting notification is a voting notification generated by the shadow node according to the block locking voting information of the service node of the to-be-processed service object. In the embodiment of this application, the voting notification of the shadow node, i.e., the first voting notification, is generated based on the relevant voting information extracted from the block locking voting information of the service node of the to-be-processed service object. Then, the shadow node broadcasts the first voting notification to each node in the blockchain network. For example, in a case that the shadow node generates its own voting notification according to the instruction of the service node of the to-be-processed service object, the shadow node broadcasts the voting notification, so that each node can receive the voting information of the shadow node to complete the prevoting function. Since the voting notification of the shadow node is generated based on the block locking voting information of its associated service node of the to-be-processed service object, the voting result of the shadow node is kept consistent with that of the service node of the to-be-processed service object, thus increasing the voting weight of the service node of the to-be-processed service object.

In order to alleviate the problem that the shadow node cannot complete prevoting since the shadow node cannot receive the block locking voting information of the service node of the to-be-processed service object in time, in some feasible embodiments, the block data processing method according to the embodiment of this application may further include S810:
S810: in a case that the block locking voting information of the service node of the to-be-processed service object is not received within the preset waiting time range, generate a default second voting notification according to default configuration information of the shadow node, and broadcast the second voting notification to each node.

In the embodiment of this application, the default configuration information refers to default content of prevoting preconfigured in the shadow node. For example, in the initialization configuration process of the shadow node, the default content of prevoting is configured, so that in a case that the shadow node does not receive the block locking voting information of the service node of the to-be-processed service object within the preset waiting time range, it can complete voting according to the default configuration information. Specifically, in the embodiment of this application, the preset waiting time range is timeout time for triggering prevoting, i.e., response timeout time for receiving the block locking voting information of the service node of the to-be-processed service object. In a case that the shadow node does not receive the block locking voting information of the service node of the to-be-processed service object within the preset waiting time range, the shadow node generates a corresponding second voting notification according to its preconfigured prevoting default content and broadcasts it to each node, thus completing the prevoting function, effectively alleviating the problem that the shadow node cannot complete prevoting since the shadow node cannot receive the block locking voting information, and improving the operation efficiency of the blockchain network.

Exemplarily, taking a game virtual resource allocation application scenario as an example, in some game application scenarios, a game target object needs to allocate its game resources, and a node voting result may influence the allocation of game resources or game rewards (such as game coins and game props). Therefore, it is required to allocate the voting weights of game target objects with different rights and interests, so as to ensure that nodes participating in consensus receive appropriate rewards according to their contributions or benefits. Correspondingly, in the embodiments of this application, corresponding service node groups are configured according to voting weight needs of different to-be-processed service objects. In a case that the shadow node in the relevant service node group needs to perform voting, it first obtain the block locking voting information of the service node of the to-be-processed service object within the preset waiting time range to generate a corresponding voting notification. In a case that the shadow node does not receive the corresponding block locking voting information within the preset waiting time range, i.e., a response timeout occurs in receiving the block locking voting information, the shadow node generates a corresponding second voting notification, i.e., a default voting notification, according to the preconfigured default configuration information, and broadcasts the second voting notification to each node to complete the prevoting process.

In order to further keep the processing behavior of the shadow node consistent with that of the service node of the to-be-processed service object and increase the voting weight of the service node of the to-be-processed service object, in some feasible embodiments, the operation of extracting, by the shadow node, in response to block locking voting information transmitted by the service node of the to-be-processed service object, first voting content from the block locking voting information, and performing block locking processing on the proposal notification may further include, but not limited, S910 to S920:
S910: in a case that the shadow node is not a proposal node, wait for proposal notifications of other nodes within the preset waiting time range.

In the embodiment of this application, the other nodes are nodes in the blockchain network except for the shadow node. In a case that the shadow node is not a proposal node, it waits for other nodes in the blockchain network to propose within certain time, i.e., the preset waiting time range. For example, after entering a new height, the shadow node first determines whether it is a proposal node at that height. In a case that it is determined that it is not a proposal node at that height, the shadow node enters a waiting state and waits for proposal information of other nodes in the blockchain network within the preset waiting time range.
S920: in a case that the proposal notification received by the shadow node comes from the service node of the to-be-processed service object, generate a default third voting notification according to default configuration information of the shadow node, and broadcast the third voting notification to each node.

In the embodiment of this application, the service node of the to-be-processed service object refers to the service node of the to-be-processed service object associated with the shadow node. In the embodiment of this application, the default configuration information refers to default voting content configured during the initialization of the shadow node. In a case that the proposal node is the service node of the to-be-processed service object associated with the shadow node, in the embodiment of this application, corresponding voting information is generated according to the default voting content. Specifically, in the embodiment of this application, in a case that the shadow node receives the proposal notification from the service node of the to-be-processed service object, the shadow node first generates a corresponding default voting notification, i.e., third voting notification, according to its default configuration information, and broadcasts it to each node in the blockchain network, thus increasing the voting weight of the service node of the to-be-processed service object.

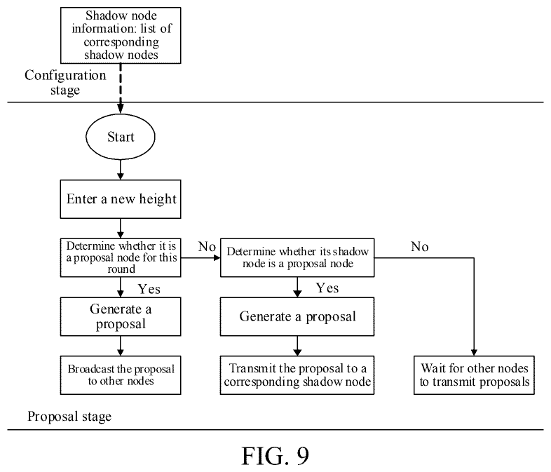

FIG. 10 is a flowchart showing consensus in a case that a service node of a to-be-processed service object is a proposal node in a current round in an environment with 4 nodes. In the figure, Node 2 and Node 1 form a service node group. Node 1 is a service node of a to-be-processed service object, and Node 2 is a shadow node associated with Node 1. Exemplarily, taking a blockchain shared state update application scenario as an example, in a case that changes occur in protocols or rules related to the blockchain, blockchain network nodes may decide whether to accept these changes by voting and update the state of the blockchain. Correspondingly, different blockchain network nodes may have different voting weights, and the number of shadow nodes in their service node groups may also vary. In a case that the shadow node is not a proposal node, the shadow node only needs to receive proposal information of other nodes in the blockchain network. In a case that the shadow node receives the proposal notification from the service node of the to-be-processed service object within the preset waiting time range, the shadow node directly generates a default voting notification according to the corresponding default configuration information and broadcasts it to each node in the blockchain network. The default configuration information has already been initialized and configured when constructing the target service node. In the embodiment of this application, the method of generating a third voting notification through the shadow node according to the default configuration information can effectively improve the operation efficiency of the blockchain network.

In order to further keep the processing behavior of the shadow node consistent with that of the service node of the to-be-processed service object and increase the voting weight of the service node of the to-be-processed service object, in some feasible embodiments, the operation of extracting, by the shadow node, in response to block locking voting information transmitted by the service node of the to-be-processed service object, first voting content from the block locking voting information, and performing block locking processing on the proposal notification may further include, but not limited, S1010 to S1020:
S1010: in a case that the proposal notification received by the shadow node does not come from the service node of the to-be-processed service object, receive the block locking voting information of the service node of the to-be-processed service object in real time within the preset waiting time range.

In the embodiment of this application, the preset waiting time range is timeout time for triggering prevoting configured in the initialization process of the shadow node, and the shadow node receives the block locking voting information within the timeout time for triggering prevoting. Specifically, after block consensus enters a new height, the shadow node first determines whether it is a proposal node at that height. In a case that it is determined that it is not a proposal node, the shadow node waits for proposal notification of other nodes within certain time. Next, after receiving the proposal notification, the shadow node analyzes the source of the proposal information. In a case that it is determined that the proposal notification does not come from the service node of the to-be-processed service object, the prevoting of the shadow node needs to be performed according to the instruction of the service node of the to-be-processed service object. In this case, the shadow node receives the block locking voting information of the service node of the to-be-processed service object in real time within the preset waiting time range. Exemplarily, taking a digital financial asset transaction application scenario as an example, in a case that the shadow node of a relevant digital financial asset target object receives a proposal notification from any other digital financial asset object in the blockchain network, i.e., the proposal notification is not a proposal notification from the service node of the to-be-processed service object corresponding to the shadow node, the shadow node needs to obtain the block locking voting information of the service node of the to-be-processed service object to generate corresponding voting information, so as to keep the processing behavior consistent with that of the service node of the to-be-processed service object. Correspondingly, the shadow node obtain the block locking voting information of the service node of the to-be-processed service object within the timeout time for triggering prevoting, i.e., the preset waiting time range. In a case that the shadow node does not receive relevant instruction information from the service node of the to-be-processed service object within the preset waiting time range, it will perform corresponding response timeout processing according to the default configuration information.
S1020: in a case that the block locking voting information of the service node of the to-be-processed service object is received within the preset waiting time, generate a fourth voting notification and broadcast the fourth voting notification to each node.

In the embodiment of this application, the fourth voting notification is voting information generated by the shadow node for the relevant proposal according to the block locking voting information. In the embodiment of this application, the voting notification of the shadow node is generated according to the voting content extracted from the block locking voting information of the service node of the to-be-processed service object, so that the shadow node can follow the voting of the service node of the to-be-processed service object, thus increasing the voting weight of the service node of the to-be-processed service object. Specifically, in a case that the shadow node receives the block locking voting information of the service node of the to-be-processed service object within the preset waiting time, in the embodiment of this application, the voting content of the service node of the to-be-processed service object is extracted from the block locking voting information. Then, the shadow node synthesizes the voting content of the service node of the to-be-processed service object to obtain a voting notification, i.e., fourth voting notification, of the shadow node. Then, the shadow node broadcasts the fourth voting notification to each node in the blockchain network to complete voting. Exemplarily, taking a blockchain decision management application scenario as an example, in some decentralized autonomous organizations or blockchain projects, nodes of different to-be-processed service objects may have different interests and perspectives. By allocating different voting weight proportions to different to-be-processed service objects, it can ensure that nodes participating in consensus have different influences in the decision making process. Correspondingly, when shadow nodes of to-be-processed service objects with different weight proportions perform prevoting, in a case that the proposal notification received by the shadow node does not come from the service node of the to-be-processed service object, it needs to receive block locking voting information from the service node of the to-be-processed service object within preset waiting time to generate a corresponding voting notification. After the shadow node obtain the block locking voting information of its associated service node of the to-be-processed service object within the preset waiting time, the shadow node extracts corresponding voting content according to the block locking voting information, generates a corresponding fourth voting notification, and broadcasts the fourth voting notification to each node in the blockchain network to perform voting. In addition, the fourth voting notification is generated according to an instruction of the service node of the to-be-processed service object, so that the voting processing behavior of the shadow node is kept consistent with that of the service node of the to-be-processed service object, thus effectively improving the influence of the voting of the corresponding to-be-processed service object.

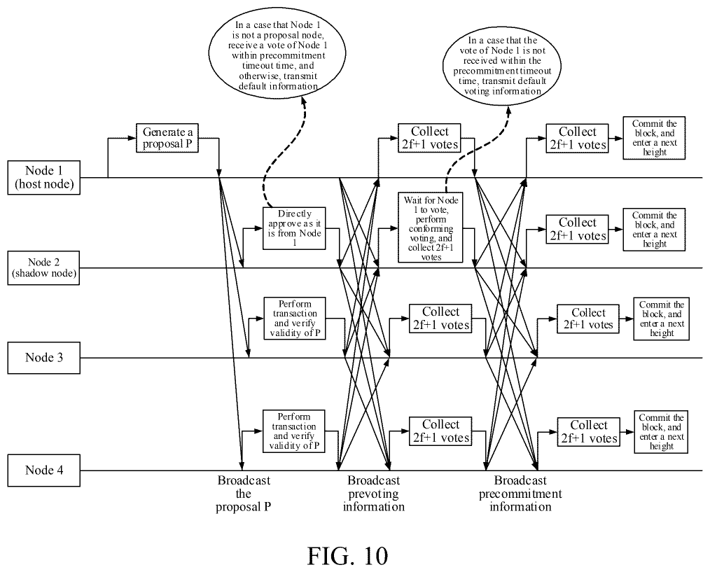

As an example FIG. 11 shows a flowchart of a consensus processing and prevoting stage of a shadow node according to an embodiment of this application. In the embodiment of this application, after broadcasting the corresponding proposal notification to other nodes, the shadow node waits for voting information, i.e., block locking voting information, broadcast by the service node of the to-be-processed service object. At the same time, after receiving the proposal notification broadcast by the shadow node, the service node of the to-be-processed service object generates corresponding block locking voting information and transmits it to the shadow node. Correspondingly, after receiving the block locking voting information of the service node of the to-be-processed service object, the shadow node first parses the block locking voting information to obtain voting information therein, i.e., first voting content, and generates new voting information, i.e., a first voting notification. Then, the shadow node broadcasts the voting information of this round to other nodes. In addition, in a case that the shadow node does not receive the voting information, i.e., the block locking voting information, of the service node of the to-be-processed service object within the preset waiting time range, it is considered that a response timeout occurs. In this case, the shadow node generates corresponding default prevoting information, i.e., the second voting notification, according to the preconfigured default configuration information, and broadcasts it to each node in the blockchain network. In a case that the shadow node is not a proposal node at that height, the shadow node first waits for proposals of other nodes within certain time. After the shadow node receives the proposal information transmitted by a relevant node, the shadow node first verifies the source of the received proposal information to determine whether the proposal comes from its associated service node of the to-be-processed service object. In a case that it is determined that the proposal comes from its associated service node of the to-be-processed service object, the shadow node directly generates corresponding voting information, i.e., a third voting notification, according to the preconfigured default configuration information, and broadcasts it to each node. On the contrary, in a case that it is determined that the proposal does not come from its associated service node of the to-be-processed service object, the shadow node enters a waiting state to wait for the prevoting information, i.e., block locking voting information, transmitted by its associated service node of the to-be-processed service object, so as to perform a processing behavior consistent with that of the service node of the to-be-processed service object according to the relevant block locking voting information.

In order to keep the processing behavior of the shadow node consistent with that of the service node of the to-be-processed service object and achieve block commitment processing, in some feasible embodiments, the operation of extracting, in response to block commitment voting information transmitted by the service node of the to-be-processed service object, second voting content from the block commitment voting information, and performing block commitment processing may include, but not limited, S1110 to S1140:
S1110: obtain block locking voting information of other nodes.

In the embodiment of this application, the block locking voting information comes from each node in the blockchain network. After the proposal node initiates a corresponding proposal, each node in the blockchain network generates corresponding block locking voting information after receiving a proposal notification and broadcasts it to each node. Specifically, in the embodiment of this application, after the shadow node broadcasts the corresponding voting notification to each node, the shadow node obtain the block locking voting information broadcast by other nodes in the blockchain network. Exemplarily, in a blockchain election voting application scenario, when a certain shadow node of a to-be-processed service object generates a voting notification according to the block locking voting information of the corresponding service node of the to-be-processed service object, and broadcasts it to each node, the shadow node obtain the block locking voting information broadcast by other nodes in the blockchain network, i.e., collects the prevoting information of other nodes. In the embodiment of this application, block locking is entered only after preset pieces of prevoting information are collected, for example, after votes of more than ⅔ of nodes are received.
S1120: after the block locking voting information of the other nodes is obtained, receive the block commitment voting information of the service node of the to-be-processed service object in real time within the preset waiting time range.

In the embodiment of this application, the preset waiting time range refers to timeout time for triggering precommitment, i.e., response timeout time for receiving the block commitment voting information of the service node of the to-be-processed service object. Specifically, in the embodiment of this application, the shadow node waits for the block commitment voting information broadcast by the service node of the to-be-processed service object within the preset waiting time range after obtaining the block locking voting information of other nodes, so as to generate a corresponding voting notification according to the block commitment voting information of the service node of the to-be-processed service object, thus achieving block commitment processing and keeping the consistency with the processing behavior of the service node of the to-be-processed service object. Exemplarily, taking a network resource application scenario as an example, a network target object needs to allocate its network resources, and a result of node voting may influence the allocation of network resources. Therefore, it is needed to allocate the voting weights of network target objects with different needs to ensure that nodes participating in consensus receive appropriate resources according to their contributions or needs. Correspondingly, after the corresponding shadow node broadcasts the corresponding prevoting information, i.e. the voting notification of the prevoting stage, to each node, it enters a precommitment stage. The shadow node first obtain block locking voting information of each node in the blockchain network. Then, the shadow node receives block commitment voting information of the service node of the to-be-processed service object in real time within a preset timeout time range for triggering precommitment, i.e., the voting information committed for the block after there is a locked block in the service node of the to-be-processed service object. In the embodiment of this application, the block voting information committed by the shadow node is extracted from the block voting information transmitted by the service node of the to-be-processed service object, and consensus on block information is completed according to the extracted block locking processing result of each node, so that the voting behavior of the shadow node is kept consistent with that of the service node of the to-be-processed service object.
S1130: in a case that the block commitment voting information of the service node of the to-be-processed service object is received within the preset waiting time range, extract second voting content from the block commitment voting information, synthesize the second voting content to obtain second voting information of the shadow node, and then generate a fifth voting notification.

In the embodiment of this application, the second voting content includes a block locking processing result of each node, i.e., a block locking processing result of each node received by the service node of the to-be-processed service object. Specifically, in the embodiment of this application, in a case that the shadow node receives the block commitment voting information transmitted by the service node of the to-be-processed service object within the preset waiting time range, the shadow node parses the block voting information, so as to extract the corresponding voting content, i.e., the second voting content, generate new voting information according to the second voting content to obtain second voting information of the shadow node, and generate a corresponding fifth voting notification. Exemplarily, taking a digital financial asset application scenario as an example, in the embodiment of this application, a corresponding service node group is constructed so that a corresponding digital financial asset to-be-processed service object has higher discourse power, i.e., higher voting weight. Correspondingly, after the shadow node of the digital financial asset to-be-processed service object receives block voting information of the service node of the to-be-processed service object, i.e., precommitment information, within a preset timeout time range for triggering precommitment, the shadow node parses the block voting information and extracts relevant voting content, such as the block locking processing result of each node, so as to synthesize corresponding voting information, i.e., second voting information, of the shadow node according to the extracted voting content, and then generate a voting notification of the shadow node. The voting notification corresponds to the voting information of the service node of the to-be-processed service object, so as to also keep the consistency with the processing behavior of the service node of the to-be-processed service object during the block commitment stage.
S1140: broadcast the fifth voting notification to each node.

In the embodiment of this application, the shadow node generates a fifth voting notification according to the block commitment voting information of the service node of the to-be-processed service object, and broadcasts the fifth voting notification to each node to achieve block commitment processing. For example, in a blockchain consensus application scenario, after the shadow node broadcasts corresponding prevoting information to each node in the blockchain network, it enters a precommitment stage. In this case, the shadow node obtain block commitment voting information from the service node of the to-be-processed service object within the preset waiting time range, so as to generate a fifth voting notification according to the voting information committed by the service node of the to-be-processed service object. Further, after generating the corresponding fifth voting notification according to the instruction of the service node of the to-be-processed service object, the shadow node broadcasts it to each node in the blockchain network to perform voting, thus achieving the block commitment function.

In order to alleviate the problem that the shadow node cannot complete precommitment since the shadow node cannot receive the block commitment voting information of the service node of the to-be-processed service object in time, in some feasible embodiments, the block data processing method according to the embodiment of this application may further include S1210:
S1210: in a case that the block commitment voting information of the service node of the to-be-processed service object is not received within the preset waiting time range, generate a default sixth voting notification according to default configuration information of the shadow node, and broadcast the sixth voting notification to each node.

In the embodiment of this application, the default configuration information includes default content of precommitment. In the initialization process of the shadow node, in the embodiment of this application, the default content of precommitment of the shadow node, i.e., the default content committed by the shadow node in a case that a response timeout occurs when the shadow node receives the block commitment voting information of the service node of the to-be-processed service object, is configured. Specifically, in the embodiment of this application, in a case that the shadow node does not receive the block commitment voting information of its associated service node of the to-be-processed service object within the preset waiting time range, the shadow node directly generates a corresponding sixth voting notification according to the default configuration information and broadcasts it. Exemplarily, taking a digital collectible application scenario as an example, in a case that a shadow node in a service node group of a corresponding digital collectible target object does not receive block commitment voting information transmitted by the corresponding service node of the to-be-processed service object within the preset waiting time range, in order to complete precommitment in time, the shadow node directly generates a default voting notification, i.e., a sixth voting notification, according to the preconfigured default configuration information. Next, the shadow node broadcasts the default voting notification to each node to complete the precommitment function, thus effectively alleviating the problem that the shadow node cannot complete precommitment since it cannot receive the block commitment voting information of the service node of the to-be-processed service object in time.

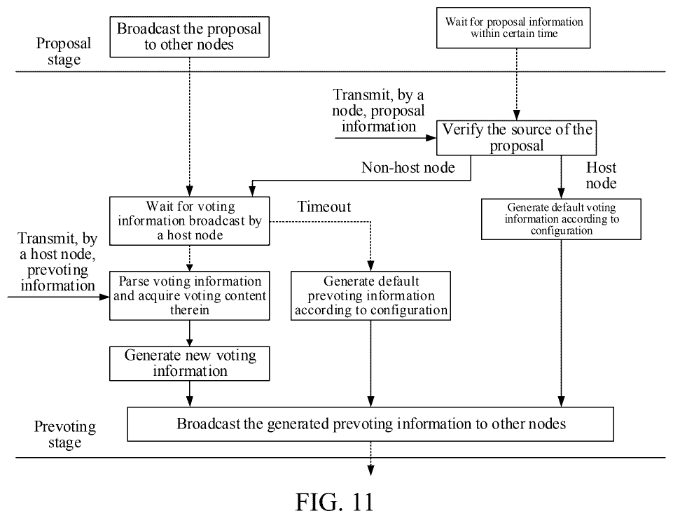

As an example, FIG. 12 shows a flowchart of a consensus processing and precommitment stage of a shadow node according to an embodiment of this application. In the embodiment of this application, after broadcasting the corresponding voting notification to each node, the shadow node obtain block locking voting information, i.e., prevoting information, of other nodes. At a specific height and round, in a case that a node receives a prevoting set of more than ⅔ of all nodes for a certain block, the node locks the block at that height and round. Therefore, in the embodiment of this application, 2f+1 prevotes need to be collected, where f is the number of abnormal nodes in the network, i.e., the number of malicious nodes. Next, the shadow node waits for precommitment voting information, i.e., block commitment voting information, broadcast by the service node of the to-be-processed service object. After receiving the block commitment voting information transmitted by the service node of the to-be-processed service object, the shadow node parses the block commitment voting information to obtain corresponding voting content, i.e., second voting content, generates new precommitment voting information, i.e., a fifth voting notification, and broadcasts it to other nodes. Correspondingly, in a case that the shadow node does not receive the precommitment voting information, i.e., the block commitment voting information, of the service node of the to-be-processed service object within the preset waiting time range, it is considered that a response timeout occurs. In this case, in the embodiment of this application, the shadow node generates default precommitment voting information, i.e., a sixth voting notification, according to the preconfigured default configuration information, and broadcasts it to each node in the blockchain network.

Exemplarily, taking a blockchain node consensus application scenario as an example, in this technical solution of this application, the complete implementation process of the block data processing method is described as follows:

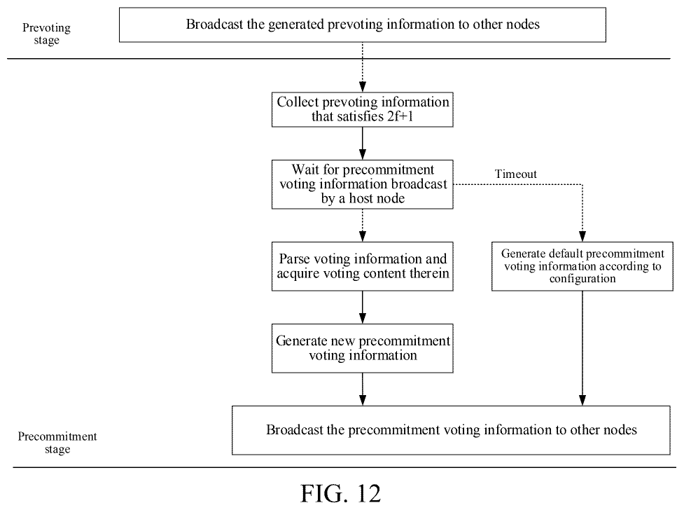

FIG. 13 is a flowchart showing overall consensus processing performed by a shadow node in a block data processing method in a specific example. After a service node group including a service node of a to-be-processed service object and a corresponding number of shadow nodes according to a voting right need of the to-be-processed service object, a corresponding node consensus process may be performed through the service node of the to-be-processed service object and the shadow nodes in the service node group. Specifically, after entering a new height, a shadow node first determines whether it is a proposal node at that height. In a case that it is determined that it is a proposal node, the shadow node waits for proposal information transmitted by the corresponding service node of the to-be-processed service object. Next, after receiving the related proposal information, the shadow node first verifies the source of the proposal information to determine whether it comes from the service node of the to-be-processed service object associated with the shadow node. After verification passes, i.e., it is determined that the proposal information comes from the service node of the to-be-processed service object, it parses the proposal information to obtain the corresponding block information, generates a new proposal notification based on the block information, and broadcasts the proposal notification to other nodes in the blockchain network. On the contrary, in a case that it is verified that the proposal information does not come from the service node of the to-be-processed service object, it is considered that a reception error occurs, and the proposal information is discarded. In addition, in a case that the shadow node waits for the corresponding service node of the to-be-processed service object to transmit the proposal information and does not receive the relevant proposal information within the preset waiting time range, it is considered that a response timeout occurs. In this case, the shadow node generates a default proposal notification according to the preconfigured default configuration information and broadcasts it to each node in the blockchain network. Moreover, in a case that the shadow node determines that the proposal node at that height is not itself, it enters a waiting stage and waits for proposal information broadcast by other nodes within certain time.

Next, after the shadow node broadcasts the corresponding proposal notification to each other node, the shadow node enters a waiting stage and waits for voting information, i.e., block locking voting information, broadcast by the corresponding service node of the to-be-processed service object. In addition, after receiving the block locking voting information transmitted by the corresponding service node of the to-be-processed service object, the shadow node first parses the block locking voting information to obtain relevant voting information, i.e., first voting content, and then generates new voting information, i.e., first voting information, according to the voting information. Moreover, in a case that a timeout occurs when the shadow node waits for the block locking voting information of the service node of the to-be-processed service object, i.e., it does not receive the relevant voting information of the service node of the to-be-processed service object within the preset waiting time range, the shadow node generates default prevoting information, i.e., a second voting notification, according to the default configuration information, and broadcasts it to each node in the blockchain network. Correspondingly, in a case that the shadow node is not a proposal node and receives the proposal information (proposal notification) within certain time, the shadow node first verifies the source of the received proposal to confirm whether the proposal notification comes from the service node of the to-be-processed service object. In a case that it is determined that the proposal notification comes from the service node of the to-be-processed service object, the shadow node directly generates default voting information, i.e., a third voting notification, according to the preconfigured default configuration information, and broadcasts it to other nodes. On the contrary, in a case that it is determined that the proposal node does not come from the service node of the to-be-processed service object, the shadow node enters a waiting stage and waits for the block locking voting information broadcast by the corresponding service node of the to-be-processed service object, so as to generate corresponding voting information (voting notification) according to the block locking information of the service node of the to-be-processed service object, and broadcast it to each in the blockchain network.

After the shadow node broadcasts the generated voting notification to each node, the shadow node first obtain block locking voting information, i.e., prevoting information, of other nodes. For example, the shadow node needs to collect block locking voting information that satisfies 2f+1, where f refers to the number of malicious nodes allowed in the entire blockchain network, and exceeding this number will decrease the security of the entire network, or even make the entire network unusable. Then, the shadow node waits for precommitment information, i.e., block commitment information, broadcast by its associated service node of the to-be-processed service object, and parses the block commitment information to obtain the voting content therein. Next, the shadow node generates new voting information (voting notification) according to the parsed voting content, i.e., the second voting content, and broadcasts it to other nodes in the blockchain network. Correspondingly, in a case that the shadow node does not receive the block commitment information of the service node of the to-be-processed service object within the preset waiting time range, it is considered that a response timeout occurs. In this case, the shadow node generates corresponding default voting information according to the default configuration information configured during initialization, i.e., the sixth voting notification, and broadcasts it to each node. Then, in a case that the node receives the block commitment information i.e., committed by more than ⅔ nodes or 2f+1 for the locked block, it will confirm the block and enter a consensus process for a block at a next height.

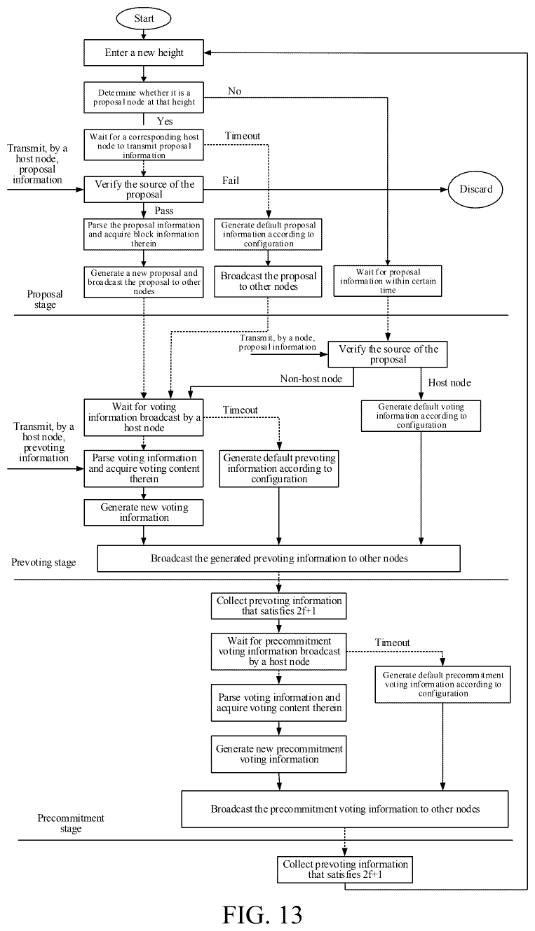

As shown in FIG. 14, an embodiment of this application further provides a block data processing apparatus deployed on an electronic device. The apparatus includes:
an obtaining module 1310 configured to obtain a voting right need of a to-be-processed service object; and
a first module 1320 configured to construct a service node group according to the voting right need of the to-be-processed service object. The service node group includes a service node of the to-be-processed service object and at least one shadow node of the service node. The service node of the to-be-processed service object is configured to perform block data processing according to stored block ledger data. The block data processing performed by the shadow node is kept consistent with the block data processing performed by the service node of the to-be-processed service object. The shadow node does not store the block ledger data for the block data processing.

In a possible implementation, the first module 1320 includes:
a first unit configured to configure one or more shadow nodes for the service node of the to-be-processed service object according to the voting right need of the to-be-processed service object; and
a second unit configured to perform initial information configuration on each shadow node, and combine a configured shadow node with the service node of the to-be-processed service object to obtain the service node group of the to-be-processed service object.

In a possible implementation, the second unit includes:
a first subunit configured to configure node mapping information between the shadow node and the service node of the to-be-processed service object, the node mapping information representing an association relationship between each shadow node and a corresponding service node of the to-be-processed service object;
a second subunit configured to configure default operation information of the shadow node, the default operation information being configured for indicating a processing action to be taken by the shadow node in the case of not receiving an instruction transmitted by the service node of the to-be-processed service object; and
a third subunit configured to configure response timeout information of the shadow node.

In combination with FIG. 14, a specific implementation process of the block data processing apparatus according to this application will be described: an obtaining module 1310 obtain a voting right need of a to-be-processed service object; a first module 1320 constructs a service node group according to the voting right need of the to-be-processed service object. Specifically, the service node group includes a service node of the to-be-processed service object and at least one shadow node. The service node of the to-be-processed service object is configured to perform block data processing according to stored block ledger data. The block data processing performed by the shadow node is kept consistent with the block data processing performed by the service node of the to-be-processed service object. The shadow node does not store the block ledger data for the block data processing. In this way, the shadow node can perform proposal processing, block locking processing, or block commitment processing according to the instruction of the service node of the to-be-processed service object to complete consensus on block information. Therefore, the shadow node does not need to store the relevant ledger data of the blockchain network, and can perform a processing behavior consistent with or default to that of the service node of the to-be-processed service object, thus reducing the amount of resources occupied by a service object with a high weight proportion, and improving the operation efficiency of the blockchain network.

An embodiment of this application further provides a block data processing apparatus deployed on a shadow node. The apparatus includes: a second module 1330 configured to extract, in response to proposal information transmitted by a service node of a to-be-processed service object, block information from the proposal information, perform proposal processing, and generate a proposal notification, the proposal notification being configured for triggering each node to perform block locking processing, the service node of the to-be-processed service object and the shadow node being located in a service node group of the to-be-processed service object, the service node group of the to-be-processed service object being constructed based on the method according to any one of embodiments described above;
a third module 1340 configured to extract, in response to block locking voting information transmitted by the service node of the to-be-processed service object, first voting content from the block locking voting information, and perform block locking processing on the proposal notification by using the first voting content; and
a fourth module 1350 configured to extract, in response to block commitment voting information transmitted by the service node of the to-be-processed service object, second voting content from the block commitment voting information, and perform block commitment processing by using the second voting content to complete consensus on the block information, the second voting content including a result of the block locking processing performed by each node.

The contents in the block data processing method embodiment shown above are applicable to the block data processing apparatus embodiment, the specific functions implemented by the block data processing apparatus embodiment are the same as those implemented the block data processing method embodiment shown above, and the beneficial effects achieved are also the same as those achieved by the block data processing method embodiment shown above.

In a possible implementation, the second module 1330 includes:
a third unit configured to, in a case that the shadow node becomes a proposal node, receive proposal information of the service node of the to-be-processed service object in real time within a preset waiting time range; and
a fourth unit configured to, in a case that the proposal information of the service node of the to-be-processed service object is received, extract block information from the proposal information, synthesize the block information to obtain a secondary proposal of the shadow node, and then generate a proposal notification.

In a possible implementation, the block data processing apparatus according to the embodiment of this application further includes:
a fifth module configured to, in a case that the proposal information of the service node of the to-be-processed service object is not received within the preset waiting time range, generate a default proposal notification according to default configuration information of the shadow node.

In a possible implementation, the block data processing apparatus according to the embodiment of this application further includes:
a fifth unit configured to broadcast the proposal notification to each node; and
the third module includes:
a sixth unit configured to, in a case that the shadow node is a proposal node, after broadcasting the proposal notification to each node, receive the block locking voting information of the service node of the to-be-processed service object in real time within the preset waiting time range;
a seventh unit configured to, in a case that the block locking voting information of the service node of the to-be-processed service object is received, extract first voting content from the block locking voting information, synthesize the first voting content to obtain first voting information of the shadow node, and then generate a first voting notification; and
an eighth unit configured to broadcast the first voting notification to each node.

In a possible implementation, the block data processing apparatus according to the embodiment of this application further includes:
a sixth module configured to, in a case that the block locking voting information of the service node of the to-be-processed service object is not received within the preset waiting time range, generate a default second voting notification according to default configuration information of the shadow node, and broadcast the second voting notification to each node.

In a possible implementation, the block data processing apparatus according to the embodiment of this application further includes:
a fifth unit configured to broadcast the proposal notification to each node; and
the third module includes:
a ninth unit configured to, in a case that the shadow node is not a proposal node, wait for proposal notifications of other nodes within the preset waiting time range; and
a tenth unit configured to, in a case that the proposal notification received by the shadow node comes from the service node of the to-be-processed service object, generate a default third voting notification according to default configuration information of the shadow node, and broadcast the third voting notification to each node.

In a possible implementation, the block data processing apparatus according to the embodiment of this application further includes:
an eleventh unit configured to, in a case that the proposal notification received by the shadow node does not come from the service node of the to-be-processed service object, receive the block locking voting information of the service node of the to-be-processed service object in real time within the preset waiting time range; and
a twelfth unit configured to, in a case that the block locking voting information of the service node of the to-be-processed service object is received within the preset waiting time, generate a fourth voting notification and broadcast the fourth voting notification to each node.

In a possible implementation, the fourth module includes:
a thirteenth unit configured to obtain block locking voting information of other nodes;
a fourteenth unit configured to, after the block locking voting information of the other nodes is obtained, receive the block commitment voting information of the service node of the to-be-processed service object in real time within the preset waiting time range;
a fifteenth unit configured to, in a case that the block commitment voting information of the service node of the to-be-processed service object is received within the preset waiting time range, extract second voting content from the block commitment voting information, synthesize the second voting content to obtain second voting information of the shadow node, and then generate a fifth voting notification; and
a sixteenth unit configured to broadcast the fifth voting notification to each node.

In a possible implementation, the block data processing apparatus according to the embodiment of this application further includes:
a seventh module configured to, in a case that the block commitment voting information of the service node of the to-be-processed service object is not received within the preset waiting time range, generate a default sixth voting notification according to default configuration information of the shadow node, and broadcast the sixth voting notification to each node.

An embodiment of this application provides a block data processing apparatus for a blockchain network. The blockchain network includes a plurality of nodes. The apparatus is deployed on an electronic device and includes:
a determination module configured to determine a service node of a to-be-processed service object from the plurality of nodes of the blockchain network;
a calculation module configured to calculate a number of shadow nodes to be configured for the service node of the to-be-processed service object according to a voting right weight expected by the service node of the to-be-processed service object and a number of nodes of the blockchain network; and
a configuration module configured to configure shadow nodes for the service node of the to-be-processed service object according to the number of shadow nodes,
the service node of the to-be-processed service object storing block ledger data for block data processing, the block data processing performed by the shadow node being kept consistent with the block data processing performed by the service node of the to-be-processed service object, the shadow node not storing the block ledger data for the block data processing.

In a possible implementation, the configuration module is configured to: configure node mapping information between the shadow node and the service
node of the to-be-processed service object, the node mapping information representing an association relationship between each shadow node and the service node of the to-be-processed service object;
configure default operation information of the shadow node, the default operation information being configured for indicating a processing action to be taken by the shadow node in the case of not receiving an instruction transmitted by the service node of the to-be-processed service object; and
configure response timeout information of the shadow node.

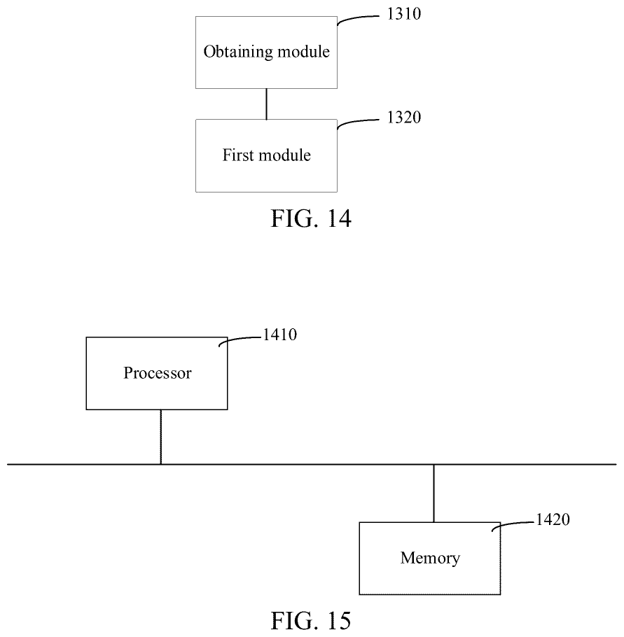

As shown in FIG. 15, an embodiment of this application further provides an electronic device. The electronic device includes a processor 1410 and a memory 1420; the memory 1420 has a program stored therein; the processor 1410 executes the program to implement the block data processing method described above; the electronic device has a function of carrying and running a software system for service data processing according to the embodiment of this application, and may be, for example, a personal computer (PC), a mobile phone, a smart phone, a personal digital assistant (PDA), a wearable device, a pocket PC (PPC), a tablet, and a vehicle-mounted terminal.

The contents in the block data processing method embodiment shown above are applicable to the electronic device embodiment, the specific functions implemented by the electronic device embodiment are the same as those implemented the block data processing method embodiment shown above, and the beneficial effects achieved are also the same as those achieved by the block data processing method embodiment shown above.

An embodiment of this application further provides a computer-readable storage medium. The storage medium has a computer program stored therein. The computer program is executed by a processor to implement the block data processing method described above. Moreover, an embodiment of this application further provides a computer program product. The computer program product includes a computer program. The computer program is stored in a computer-readable storage medium. A processor of an electronic device may read the computer program from the computer-readable storage medium. The processor executes the computer program to cause the electronic device to perform the block data processing method described above.

The contents in the block data processing method embodiment shown above are applicable to the computer-readable storage medium embodiment, the specific functions implemented by the computer-readable storage medium embodiment are the same as those implemented the block data processing method embodiment shown above, and the beneficial effects achieved are also the same as those achieved by the block data processing method embodiment shown above.

The contents in the block data processing method embodiment shown above are applicable to the computer program product embodiment, the specific functions implemented by the computer program product embodiment are the same as those implemented the block data processing method embodiment shown above, and the beneficial effects achieved are also the same as those achieved by the block data processing method embodiment shown above.

In some alternative embodiments, the functions/operations mentioned in the block diagrams may not occur in the order mentioned in the operation diagrams. For example, depending on the functions/operations involved, two consecutive boxes may actually be executed substantially and simultaneously or boxes may sometimes be executed in a reverse order. In addition, the embodiments presented and described in the flowcharts of this application are provided by way of examples in order to provide a more comprehensive understanding of the technology. The disclosed methods are not limited to the operations and logical processes presented herein. The alternative embodiments are predictable, where the order of various operations is changed and sub-operations described as part of larger operations are independently executed.

From the embodiments provided in the above specification, it is clear that the technical solution of this application has at least the following beneficial effects:

In some alternative embodiments, the functions/operations mentioned in the block diagrams may not occur in the order mentioned in the operation diagrams. For example, depending on the functions/operations involved, two consecutive boxes may actually be executed substantially and simultaneously or boxes may sometimes be executed in a reverse order. In addition, the embodiments presented and described in the flowcharts of this application are provided by way of examples in order to provide a more comprehensive understanding of the technology. The disclosed methods are not limited to the operations and logical processes presented herein. The alternative embodiments are predictable, where the order of various operations is changed and sub-operations described as part of larger operations are independently executed.

In addition, although this application is described in the context of functional modules, unless otherwise stated to the contrary, one or more of the functions and/or features described may be integrated into a single physical apparatus and/or software module, or one or more functions and/or features may be implemented in a separate physical apparatus or software module. A detailed discussion about the actual implementation of each module is unnecessary for understanding this application. More precisely, considering the attributes, functions, and internal relationships of various functional modules in the apparatus disclosed herein, the actual implementation of the modules will be understood within the conventional technology of engineers. Therefore, those skilled in the art can implement this application as described in the claims by adopting ordinary techniques without carrying excessive tests. The specific concepts disclosed are only descriptive and are not intended to limit the scope of this application. The scope of this application is determined by the full scope of the attached claims and their equivalents.

In a case that the functions are implemented in the form of a software functional unit and sold or used as an independent product, the functions may be stored in a computer-readable storage medium. Based on such an understanding, the technical solutions of this application essentially, or the part contributing to the related art, or some of the technical solutions may be implemented in a form of a software product. The computer software product is stored in a storage medium, and includes several instructions for instructing a computer device (which may be a personal computer, a server, or a network device) to perform all or some of the operations of the methods described in the embodiments of this application. The storage medium includes various media capable of storing program codes, such as a USB flash drive, a mobile hard disk, a read-only memory (ROM), a random access memory (RAM), a magnetic disk, and an optical disc.

The logic and/or operations shown in the flowcharts or described in any other manner herein, for example, a sequenced list that may be considered as executable instructions configured for implementing logical functions, may be specifically implemented in any computer-readable medium to be used by an instruction execution system, apparatus, or device (for example, a computer-based system, a system including a processor, or another system that can obtain an instruction from the instruction execution system, apparatus, or device and execute the instruction) or to be used by combining such instruction execution systems, apparatuses, or devices. In the specification of this application, the “computer-readable medium” may be any apparatus that can include, store, communicate, propagate, or transmit programs to be used by the instruction execution system, apparatus or device or to be used in combination with the instruction execution system, apparatus or device.

More specific examples (non-exhaustive) of the computer-readable medium include the following: an electrical connection (electronic apparatus) having one or more wires, a portable computer diskette (magnetic apparatus), a random access memory (RAM), a read-only memory (ROM), an erasable programmable read-only memory (EPROM or flash memory), an optical fiber apparatus, and a portable compact disk read-only memory (CDROM). In addition, the computer-readable medium may even be paper or other suitable media on which the program can be printed, because the program may be obtained electronically by, for example, optically scanning paper or other media, then editing, interpreting, or processing in other suitable ways if needed, and then storing it in a computer memory.

All parts of this application may be implemented by using hardware, software, firmware, or a combination thereof. In the above implementations, a plurality of operations or methods may be implemented by using software or firmware that are stored in a memory and are executed by a proper instruction execution system. For example, if hardware is configured to carry out implementation, same as in another implementation, implementation may be performed by any one of the following technologies well known in the art or a combination thereof: a discrete logic circuit including a logic gate circuit for implementing a logic function of a data signal, a dedicated integrated circuit including a proper combined logic gate circuit, a programmable gate array (PGA), a field programmable gate array (FPGA), and the like.

In the descriptions of this specification, descriptions of a reference term such as “an embodiment,” “some embodiments,” “an example,” “a specific example,” or “some examples” means that a feature, structure, material, or characteristic i.e., described with reference to the embodiment or the example is included in at least one embodiment or example of this application. In this specification, exemplary descriptions of the foregoing terms do not necessarily refer to the same embodiment or example. In addition, the described specific features, structures, materials, or characteristics may be combined in a proper manner in any one or more of the embodiments or examples.

Although the embodiments of this application have been shown and described, those skilled in the art may understand that a variety of changes, modifications, substitutions, and variations may be made to these embodiments without departing from the principle and the purpose of this application, and the scope of this application is defined by the claims and their equivalents.

What are specifically described above are exemplary embodiments of this application, but this application is not limited to the embodiments described above. Those skilled in the art may further make various equivalent modifications or replacements without departing from the spirit of this application, which, however, are all included within the scope defined by the claims of this application.

What is claimed is:

1. A block data processing method executed by an electronic device, comprising:
obtaining a voting right need of a target service object; and
constructing a service node group of the target service object according to the voting right need of the target service object, the service node group including a service node of the target service object and at least one shadow node corresponding to the service node;
wherein:
the service node is configured to perform block data processing according to stored block ledger data; and
block data processing performed by each of the at least one shadow node is kept consistent with block data processing performed by the service node, and the at least one shadow node does not store the block ledger data for block data processing.

2. The block data processing method according to claim 1, wherein constructing the service node group includes:
configuring the at least one shadow node for the service node according to the voting right need of the target service object;
performing initial information configuration on the at least one shadow node; and
combining the at least one shadow node that has been configured with the service node to obtain the service node group.

3. The block data processing method according to claim 2, wherein performing initial information configuration on the at least one shadow node includes, for one shadow node of the at least one shadow node:
configuring node mapping information between the one shadow node and the service node, the node mapping information representing an association relationship between the one shadow node and the service node;
configuring default operation information of the one shadow node, the default operation information indicating a processing action to be taken by the one shadow node in a case of not receiving an instruction transmitted by the service node; and
configuring response timeout information of the one shadow node.

4. An electronic device comprising:
a memory storing a program; and
a processor configured to execute the program to implement the method according to claim 1.

5. A non-transitory computer-readable storage medium storing a computer program that, when executed by a processor, causes an electronic device including the processor to implement the method according to claim 1.

6. A block data processing method executed by a shadow node, comprising:
extracting, in response to proposal information transmitted by a service node of a target service object, block information from the proposal information, performing proposal processing, and generating a proposal notification, the proposal notification being configured for triggering one or more nodes to perform block locking processing, and the service node and the shadow node being located in a service node group of the target service object;
in response to block locking voting information transmitted by the service node, extracting first voting content from the block locking voting information, and performing block locking processing on the proposal notification by using the first voting content; and
in response to block commitment voting information transmitted by the service node, extracting second voting content from the block commitment voting information, and performing block commitment processing by using the second voting content to complete consensus on the block information, the second voting content including a result of block locking processing performed by the one or more nodes.

7. The block data processing method according to claim 6, wherein extracting the block information, performing proposal processing, and generating the proposal notification includes:
in a case that the shadow node becomes a proposal node, detecting in real time whether the proposal information is received within a preset waiting time range; and
in response to receiving the proposal information, extracting the block information from the proposal information, synthesizing the block information to obtain a secondary proposal of the shadow node, and generating the proposal notification.

8. The block data processing method according to claim 7, further comprising:
in response to not receiving the proposal information within the preset waiting time range, generating a default proposal notification according to default configuration information of the shadow node.

9. The block data processing method according to claim 7, further comprising:
broadcasting the proposal notification to the one or more nodes;
wherein extracting the first voting content and performing block locking processing on the proposal notification by using the first voting content includes:
in a case that the shadow node is a proposal node, after broadcasting the proposal notification, detecting in real time whether the block locking voting information is received within the preset waiting time range;
in response to receiving the block locking voting information, extracting the first voting content from the block locking voting information, synthesizing the first voting content to obtain voting information of the shadow node, and generating a voting notification; and
broadcasting the voting notification to the one or more nodes.

10. The block data processing method according to claim 9, further comprising:
in response to not receiving the block locking voting information within the preset waiting time range, generating a default voting notification according to default configuration information of the shadow node, and broadcasting the default voting notification to the one or more nodes.

11. The block data processing method according to claim 7, further comprising:
broadcasting the proposal notification to the one or more nodes;
wherein extracting the first voting content and performing block locking processing on the proposal notification by using the first voting content includes:
in a case that the shadow node is not a proposal node, waiting for a proposal notification of one or more other nodes within the preset waiting time range; and
in response to the proposal notification received by the shadow node coming from the service node, generating a default voting notification according to default configuration information of the shadow node, and broadcasting the default voting notification to each node.

12. The block data processing method according to claim 11, further comprising:
in response to the proposal notification received by the shadow node not coming from the service node, detecting in real time whether the block locking voting information of the service node is received within the preset waiting time range; and
in response to receiving the block locking voting information of the service node within the preset waiting time, generating another voting notification and broadcasting the another voting notification to the one or more nodes.

13. The block data processing method according to claim 6, wherein extracting the second voting content and performing block commitment processing by using the second voting content includes:
after obtaining block locking voting information of one or more other nodes, detecting in real time whether the block commitment voting information of the service node is received within a preset waiting time range;
in response to receiving the block commitment voting information of the service node within the preset waiting time range, extracting the second voting content from the block commitment voting information, synthesizing the second voting content to obtain voting information of the shadow node, and generating a voting notification; and
broadcasting the voting notification to the one or more nodes.

14. The block data processing method according to claim 13, further comprising:
in response to not receiving the block commitment voting information of the service node within the preset waiting time range, generating a default voting notification according to default configuration information of the shadow node, and broadcasting the default voting notification to the one or more nodes.

15. An electronic device comprising:
a memory storing a program; and
a processor configured to execute the program to implement the method according to claim 6.

16. A non-transitory computer-readable storage medium storing a computer program that, when executed by a processor, causes an electronic device including the processor to implement the method according to claim 6.

17. A block data processing method executed by an electronic device, comprising:
determining a service node of a target service object from a plurality of nodes of a blockchain network;
calculating a number of shadow nodes to be configured for the service node according to a voting right weight expected by the service node and a number of nodes of the blockchain network; and
configuring one or more shadow nodes for the service node according to the number of shadow nodes;
wherein:
the service node stores block ledger data for block data processing; and
block data processing performed by each of the one or more shadow nodes is kept consistent with block data processing performed by the service node, and the one or more shadow nodes do not store the block ledger data for block data processing.

18. The block data processing method according to claim 17, wherein configuring the one or more shadow nodes includes, for one shadow node of the one or more shadow nodes:
configuring node mapping information between the one shadow node and the service node, the node mapping information representing an association relationship between the one shadow node and the service node;
configuring default operation information of the one shadow node, the default operation information indicating a processing action to be taken by the one shadow node in a case of not receiving an instruction transmitted by the service node; and
configuring response timeout information of the shadow node.

19. An electronic device comprising:
a memory storing a program; and
a processor configured to execute the program to implement the method according to claim 17.

20. A non-transitory computer-readable storage medium storing a computer program that, when executed by a processor, causes an electronic device including the processor to implement the method according to claim 17.
